(19) United States
(12) Patent Application Publication
(10) Pub. No.: US 2022/0224159 A1
(43) Pub. Date: Jul. 14, 2022

(54) WIRELESS POWER AND DATA TRANSMISSION APPARATUS AND TRANSMISSION MODULE

(71) Applicant: Panasonic Intellectual Property Management Co., Ltd., Osaka (JP)

(72) Inventors: Masato MATSUMOTO, Osaka (JP); Eiji TAKAHASHI, Nara (JP); Hideaki MIYAMOTO, Osaka (JP); Tsutomu SAKATA, Osaka (JP)

(21) Appl. No.: 17/606,194

(22) PCT Filed: Apr. 17, 2020
(86) PCT No.: PCT/JP2020/016898

§ 371 Date: Oct. 25, 2021

(30) Foreign Application Priority Data
Apr. 26, 2019 (JP) 2019-085421

(51) Int. Cl. H02J 50/12; H02J 50/80; H02J 50/05; H01F 38/18; H04B 5/00

(52) U.S. Cl. CPC H02J 50/12; H02J 50/80; H04B 5/0037; H01F 38/18; H02J 50/05

(57) ABSTRACT

A wireless power and data transmission apparatus includes an inner module and an outer module. The inner module includes: an annular-shaped first antenna disposed around an axis; and an annular-shaped first communication electrode disposed around the axis, the first communication electrode being at a different position from that of the first antenna regarding a direction along the axis. The outer module includes: an annular-shaped second antenna disposed around the axis, the second antenna performing power transmission or power reception with the first antenna via magnetic field coupling or electric field coupling; and an annular-shaped second communication electrode disposed around the axis, the second communication electrode being at a different position from that of the second antenna regarding the direction along the axis, and the second antenna performing communications with the first communication electrode via electric field coupling.

### TECHNICAL FIELD

The present disclosure relates to a wireless power and data transmission apparatus and a transmission module.

### BACKGROUND ART

Systems which transmit electric power wirelessly, i.e., contactlessly, and which also transmit data are known. For example, Patent Document 1 discloses an apparatus which wirelessly transmits energy and data between two objects that are capable of relative rotation with respect to each other around an axis of rotation. This apparatus includes two coils of a circular or circular arc shape that perform energy transmission, and two electrical conductors of a circular or circular arc shape that perform data transmission. The two coils are spaced apart in an opposing relationship along the axial direction of the axis of rotation, and perform energy transmission via magnetic field coupling. The two electrical conductors are disposed so as to be coaxial with the two coils. The electrical conductors are spaced apart in an opposing relationship along the axial direction, and perform data transmission via electromagnetic field coupling. Between the two coils and the two electrical conductors, objects for shielding purposes being made of an electrically conductive material are placed.

Patent Document 2 discloses a contactless rotary interface which perform differential signal transmission between two pairs of balanced transmission lines that are provided for two cores that are capable of making relative rotations.

CITATION LIST

### Patent Literature

[Patent Document 1] Japanese Laid-Open Patent Publication No. 2016-174149

[Patent Document 2] Japanese National Phase PCT Laid-Open Publication No. 2010-541202

### SUMMARY OF INVENTION

### Technical Problem

The present disclosure provides a technique which allows a device in which electric power and data are wirelessly transmitted between two objects undergoing relative rotations with each other to have a smaller radius.

### Solution to Problem

A wireless power and data transmission apparatus according to an embodiment of the present disclosure includes an inner module and an outer module. At least one of the inner module and the outer module is disposed so as to be capable of rotating around an axis. The inner module includes: an annular-shaped first antenna disposed around the axis; and an annular-shaped first communication electrode disposed around the axis, the first communication electrode being at a different position from that of the first antenna regarding a direction along the axis. The outer module includes: an annular-shaped second antenna disposed around the axis, the second antenna performing power transmission or power reception with the first antenna via magnetic field coupling or electric field coupling; and an annular-shaped second communication electrode disposed around the axis, the second communication electrode being at a different position from that of the second antenna regarding the direction along the axis, and the second antenna performing communications with the first communication electrode via electric field coupling.

A transmission module according to another embodiment of the present disclosure is for use as the inner module in the wireless power and data transmission apparatus.

A transmission module according to still another embodiment of the present disclosure is for use as the outer module in the wireless power and data transmission apparatus.

General or specific aspects of the present disclosure may be implemented using an apparatus, a system, a method, an integrated circuit, a computer program, or a storage medium, or any combination of an apparatus, a system, a method, an integrated circuit, a computer program, and/or a storage medium.

### Advantageous Effects of Invention

According to an embodiment of the present disclosure, communication quality can be improved in a system in which electric power and data are wirelessly transmitted between a power transmitting module and a power receiving module.

### BRIEF DESCRIPTION OF DRAWINGS

FIG. 1 is a diagram schematically showing an example of a robot arm apparatus having a plurality of movable sections.

FIG. 2 is a diagram schematically showing a wiring configuration in a conventional robot arm apparatus.

FIG. 3 is a diagram showing a specific example of the conventional configuration shown in FIG. 2.

FIG. 4 is a diagram showing an example of a robot in which power transmission in each joint is achieved wirelessly.

FIG. 5 is a diagram showing an example of a robot arm apparatus in which wireless power transmission is applied.

FIG. 6 is a cross-sectional view showing examples of a power transmitting module and a power receiving module in a wireless power and data transmission apparatus.

FIG. 7 is an upper plan view of the power transmitting module shown in FIG. 6 as viewed along an axis C.

FIG. 8 is a perspective view showing an example configuration of the magnetic core.

FIG. 9 is a cross-sectional view showing the configuration of a wireless power and data transmission apparatus according to an illustrative embodiment.

FIG. 10A is a diagram showing the structure along a cross section taken along line A-A in FIG. 9.

FIG. 10B is a diagram showing the structure along a cross section taken along line B-B in FIG. 9.

FIG. 11 is a perspective view showing an exemplary configuration of a wireless power and data transmission apparatus.

FIG. 12 is a cross-sectional view showing another exemplary configuration of a wireless power and data transmission apparatus.

FIG. 13 is a cross-sectional view showing still another exemplary configuration of a wireless power and data transmission apparatus.

FIG. 14 is a cross-sectional view showing still another exemplary configuration of a wireless power and data transmission apparatus.

FIG. 15 is a cross-sectional view showing still another exemplary configuration of a wireless power and data transmission apparatus.

FIG. 16 is a diagram showing an example of a wireless power and data transmission apparatus which allows the inner module and the outer module to be easily separated.

FIG. 17 is a cross-sectional view showing still another exemplary configuration of a wireless power and data transmission apparatus.

FIG. 18 is a diagram showing another example of a wireless power and data transmission apparatus which allows the inner module and the outer module to be easily separated.

FIG. 19 is a cross-sectional view showing still another exemplary configuration of a wireless power and data transmission apparatus.

FIG. 20 is a cross-sectional view showing still another exemplary configuration of a wireless power and data transmission apparatus.

FIG. 21 is a cross-sectional view showing still another exemplary configuration of a wireless power and data transmission apparatus.

FIG. 22 is a cross-sectional view showing still another exemplary configuration of a wireless power and data transmission apparatus.

FIG. 23 is a cross-sectional view showing still another exemplary configuration of a wireless power and data transmission apparatus.

FIG. 24 is a cross-sectional view showing still another exemplary configuration of a wireless power and data transmission apparatus.

FIG. 25 is a cross-sectional view showing still another exemplary configuration of a wireless power and data transmission apparatus.

FIG. 26 is a cross-sectional view showing still another exemplary configuration of a wireless power and data transmission apparatus.

FIG. 27 is a cross-sectional view showing still another exemplary configuration of a wireless power and data transmission apparatus.

FIG. 28 is a cross-sectional view showing still another exemplary configuration of a wireless power and data transmission apparatus.

FIG. 29 is a cross-sectional view showing still another exemplary configuration of a wireless power and data transmission apparatus.

FIG. 30A is a diagram showing another exemplary configuration of the communication electrodes and the communication circuits.

FIG. 30B is a diagram showing still another exemplary configuration of the communication electrodes and the communication circuits.

FIG. 31A is a diagram showing still another exemplary configuration of the communication electrodes and the communication circuits.

FIG. 31B is a diagram showing still another exemplary configuration of the communication electrodes and the communication circuits.

FIG. 32A is an example method of terminating each communication electrode.

FIG. 32B is another example method of terminating each communication electrode.

FIG. 33 is a diagram showing examples of magnetic field intensity distribution.

FIG. 34 is a block diagram showing the configuration of a system that includes a wireless power and data transmission apparatus.

FIG. 35A is a diagram showing an exemplary equivalent circuit for a transmission coil and a reception coil.

FIG. 35B is a diagram showing another exemplary equivalent circuit for a transmission coil and a reception coil.

FIG. 36A is a diagram showing an example configuration of a full-bridge type inverter circuit.

FIG. 36B is a diagram showing an example configuration of a half-bridge type inverter circuit.

FIG. 37 is a diagram showing another exemplary configuration of a wireless power and data transmission apparatus.

FIG. 38 is a block diagram showing the configuration of a wireless power transmission system including two wireless power feeding units.

FIG. 39A is a diagram showing a wireless power transmission system which includes one wireless power feeding unit.

FIG. 39B is a diagram showing a wireless power transmission system which includes two wireless power feeding units.

FIG. 39C shows a wireless power transmission system which includes three or more wireless power feeding units.

### DESCRIPTION OF EMBODIMENTS

(Findings Providing the Basis of the Present Disclosure)

Prior to describing embodiments of the present disclosure, findings providing the basis of the present disclosure will be described.

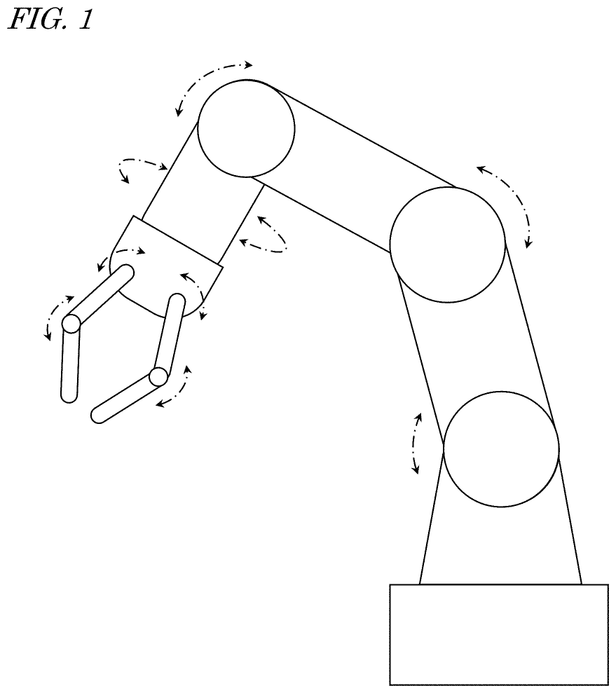

FIG. 1 is a diagram schematically showing an example of a robot arm apparatus having a plurality of movable sections (e.g., joints). Each movable section is constructed so as to be capable of rotation or expansion/contraction by means of an actuator that includes an electric motor (hereinafter simply referred to as a “motor”). In order to control such an apparatus, it is required to individually supply electric power to the plurality of motors and control them. Supply of electric power from a power source to the plurality of motors has conventionally been achieved through connection via a large number of cables.

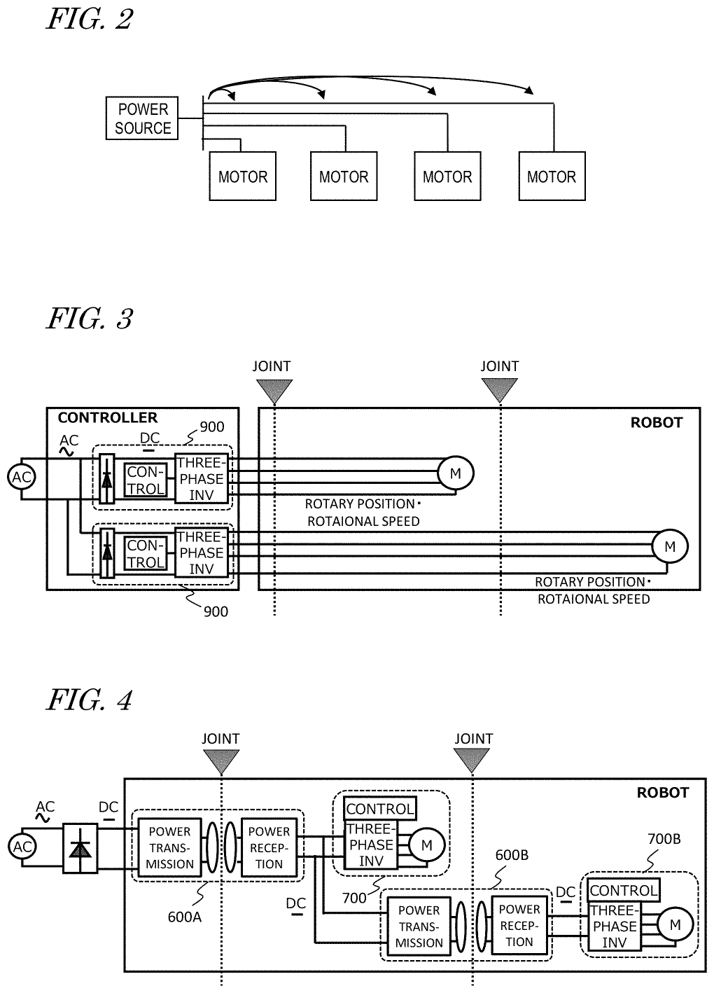

FIG. 2 is a diagram schematically showing connection between component elements in such a conventional robot arm apparatus. In the configuration shown in FIG. 2, electric power is supplied from a power source to a plurality of motors via wired bus connections. Each motor is controlled by a control device (controller) not shown.

FIG. 3 is a diagram showing a specific example of the conventional configuration shown in FIG. 2. A robot in this example has two joints. Each joint is driven by a servo motor M. Each servo motor M is driven with a three-phase AC power. The controller includes as many motor driving circuits 900 as there are motors M to be controlled. Each motor driving circuit 900 includes a converter, a three phase inverter, and a control circuit. The converter converts alternating current (AC) power from a power source into direct current (DC) power. The three phase inverter converts the DC power which is output from the converter into a three-phase AC power, and supplies it to the motor M. The control circuit controls the three phase inverter to supply necessary electric power to the motor M. The motor driving circuit 900 obtains information concerning rotary position and rotational speed from the motor M, and adjusts the voltage of each phase based on this information. Such a configuration allows the operation of each joint to be controlled.

However, in this configuration, a large number of cables need to be provided, as adapted to the number of motors. This causes accidents due to snagging of cables, which leads to the problems of limited ranges of motion and difficulty in changing parts. There also arises a problem in that repetitive bending of cables may deteriorate the cables, or even disrupt them. For improved safety and vibration control, there is a desire to internalize cables within the arm. Doing so would however require a large number of cables to be accommodated in the joints, which poses constraints on the assembly of the robot and the automation of the production steps. Therefore, the inventors have sought to reduce the number of cables in a movable section of a robot arm by applying a wireless power transmission technique.

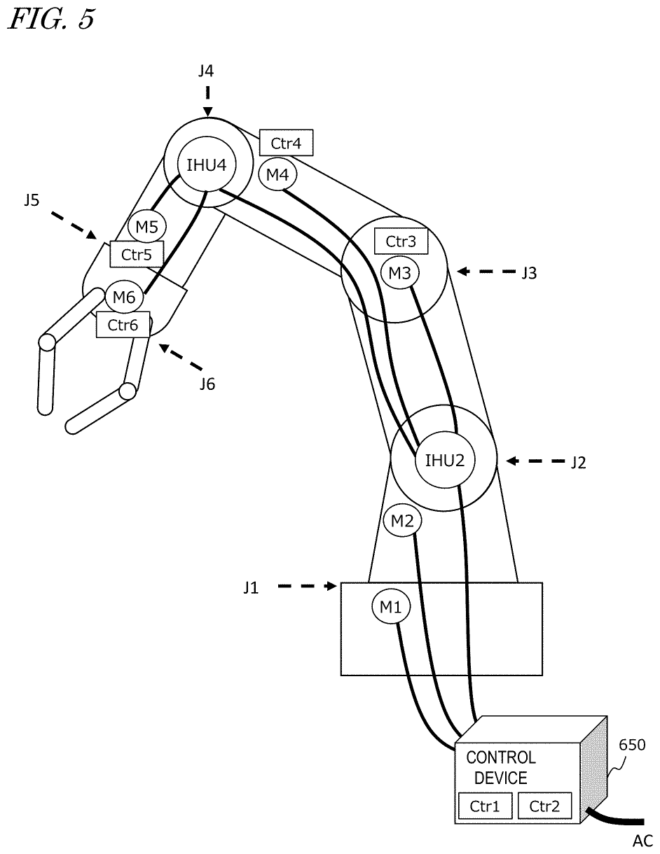

FIG. 4 is a diagram showing an example configuration of a robot in which power transmission in each joint is achieved wirelessly. In this example, unlike in the example of FIG. 3, a three phase inverter and a control circuit to drive each motor M are provided within the robot, rather than in an external controller. In each joint, wireless power transmission is performed through magnetic field coupling between a transmission coil and a reception coil. In each joint, this robot includes a wireless power feeding unit and a miniature motor. Each miniature motor 700A, 700B includes a motor M, a three phase inverter, and a control circuit. Each wireless power feeding unit 600A, 600B includes a power transmitting circuit, a transmission coil, a reception coil, and a power receiving circuit. The power transmitting circuit includes an inverter circuit. The power receiving circuit includes a rectifier circuit. The power transmitting circuit in the left wireless power feeding unit 600A shown in FIG. 4, which is connected between a power source and the transmission coil, converts the supplied DC power into AC power, and supplies it to the transmission coil. The power receiving circuit converts the AC power which the reception coil has received from the transmission coil into DC power, and outputs it. The DC power which has been output from the power receiving circuit is supplied not only to the miniature motor 700A, but also the power transmitting circuit in the wireless power feeding unit 600B in any other joint. In this manner, electric power is also supplied to the miniature motors 700B driving the other joints.

FIG. 5 is a diagram showing an example of a robot arm apparatus in which the above-described wireless power transmission is applied. This robot arm apparatus has joints J1 to J6. Among these, the above-described wireless power transmission is applied to the joints J2 and J4. On the other hand, conventional wired power transmission is applied to the joints J1, J3, J5, and J6. The robot arm apparatus includes: a plurality of motors Ml to M6 which respectively drive the joints J1 to J6; motor control circuits Ctr3 to Ctr6 which respectively control the motors M3 to M6 among the motors M1 to M6; and two wireless power feeding units (intelligent robot harness units; also referred to as IHUs) IHU2 and IHU4 which are respectively provided in the joints J2 and J4. Motor control circuits Ctr1 and Ctr2 which respectively drive the motors M1 and M2 are provided in a control device 650 which is external to the robot.

The control device 650 supplies electric power to the motors M1 and M2 and the wireless power feeding unit IHU2 in a wired manner. At the joint J2, the wireless power feeding unit IHU2 wirelessly transmits electric power via a pair of coils. The transmitted electric power is then supplied to the motors M3 and M4, the control circuits Ctr3 and Ctr4, and the wireless power feeding unit IHU4. The wireless power feeding unit IHU4 also wirelessly transmits electric power via a pair of coils in the joint J4. The transmitted electric power is supplied to the motors M5 and M6 and the control circuits Ctr5 and Ctr6. With such a configuration, cables for power transmission can be eliminated in the joints J2 and J4.

In such a system, in each wireless power feeding unit, not only power transmission but also data transmission may be performed. For example, signals for controlling each motor, or signals that are fed back from each motor, may be transmitted between a power transmitting module and a power receiving module within the wireless power feeding unit. Alternatively, in the case where a camera is mounted at the tip of the robot arm, data of images that are taken with the camera may be transmitted. In the case where a sensor is mounted at the tip, etc., of the robot arm, a group of data representing information obtained by the sensor may be transmitted Such a wireless power feeding unit, which simultaneously performs power transmission and data transmission, will be referred to as a “wireless power and data transmission apparatus” in the present specification.

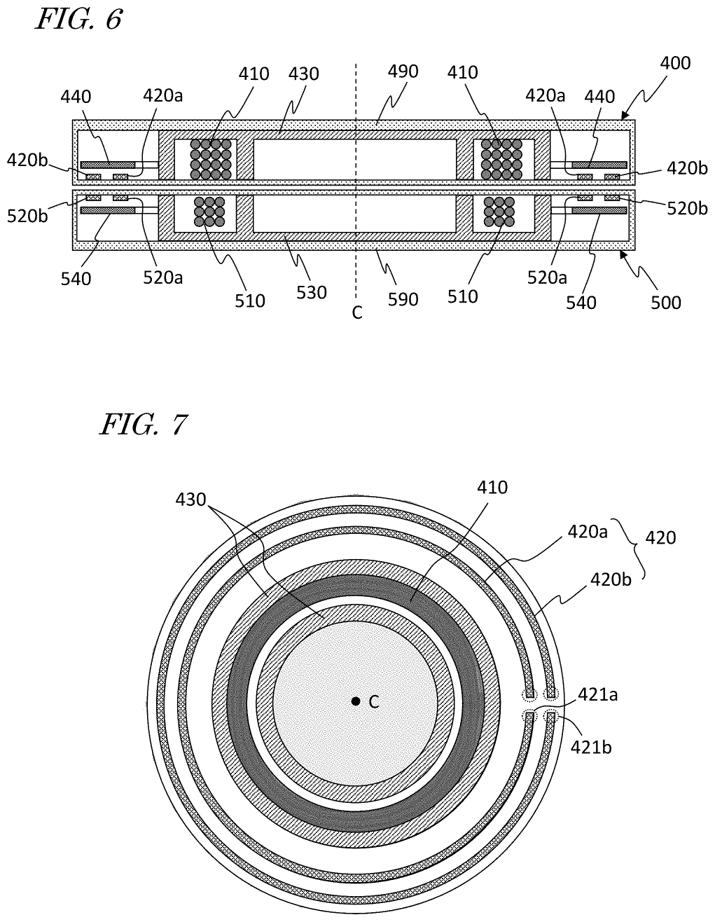

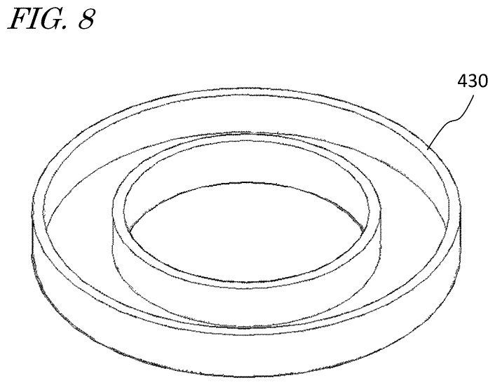

FIG. 6 is a cross-sectional view showing an example configuration of a power transmitting module 400 and a power receiving module 500 of the wireless power and data transmission apparatus. FIG. 7 is an upper plan view of the power transmitting module 400 shown in FIG. 6 as viewed along an axis C. The power receiving module 500 also has a similar structure to the structure shown in FIG. 7. At least one of the power transmitting module 400 and the power receiving module 500 can make a relative rotation around the axis C by means of an actuator not shown.

The power transmitting module 400 in the example of FIG. 6 includes: a transmission coil 410; communication electrodes including two electrodes 420a and 420b functioning as differential transmission lines; a magnetic core 430; a communication circuit 440; and a housing 490 accommodating these. In the following description, two electrodes or lines functioning as differential transmission lines may be collectively referred to as a “differential transmission line pair”.

As shown in FIG. 7, the transmission coil 410 has a circular shape around the axis C. The two electrodes 420a and 420b have a circular arc shape (or a slitted circular shape) around the axis C. The two electrodes 420a and 420b adjoin one another via an interspace. The communication electrodes 420 and the transmission coil 410 are located on the same plane. On the outside of the transmission coil 410, the communication electrodes 420 is located so as to surround the transmission coil 410. The transmission coil 410 is accommodated in the magnetic core 430.

In the configuration shown in FIGS. 6 and 7, with respect to the axis C, the transmission coil 410 and the reception coil 510 are disposed on the inner side of the radius, whereas the communication electrodes 420 and 520 are disposed on the outer side of the radius. Contrary to this configuration, a configuration may be possible in which the communication electrodes 420 and 520 are disposed on the inner side of the radius and in which the transmission coil 410 and the reception coil 510 are disposed on the outer side of the radius.

FIG. 8 is a perspective view showing an example configuration of the magnetic core 430. The magnetic core 430 shown in FIG. 8 includes an inner peripheral wall and an outer peripheral wall in a concentric arrangement, and a bottom portion connecting the two. The magnetic core 430 is made of a magnetic material. Between the inner peripheral wall and the outer peripheral wall of the magnetic core 430, the transmission coil 410 in a wound-around form is disposed. As shown in FIG. 7, the magnetic core 430 is disposed so that its center coincides with the axis C. The outer peripheral wall of the magnetic core 430 is located between the transmission coil 410 and the electrode 420a. As shown in FIG. 6, the magnetic core 430 is disposed so that an open portion that is opposite to its bottom is opposed to the power receiving module 200.

Input/output terminals of the communication circuit 440 are connected to one end 421a of the electrode 420a and one end 421b of the electrode 420b shown in FIG. 7. During transmission, the communication circuit 440 supplies two signals which are opposite in phase but equal in amplitude to the one end 421a of the electrode 420a and the one end 421b of the electrode 420b. During reception, the communication circuit 440 receives two signals which have been sent from the one end 421a of the electrode 420a and the one end 421b of the electrode 420b. Through differential arithmetics of the two signals, the communication circuit 440 is able to demodulate the transmitted signal. The other ends of the electrodes 420a and 420b may be connected to ground (GND), for example.

Thus, the two electrodes 420a and 420b function as differential transmission lines. Since data transmission via differential transmission lines is less susceptible to electromagnetic noises, communication quality can be improved. In the example of FIG. 6, the communication circuit 440 may be disposed at positions opposed to the two electrodes 420a and 420b.

The transmission coil 410 is connected to a power transmitting circuit not shown. The power transmitting circuit supplies AC power to the transmission coil 410. The power transmitting circuit may include an inverter circuit to convert DC power into AC power, for example. The power transmitting circuit may include a matching circuit for impedance matching purposes. The power transmitting circuit may also include a filter circuit to suppress electromagnetic noise.

Except for the portion opposed to the housing 490 of the power receiving module 500, the housing 490 may be made of an electrically conductive material. The housing 490 suppresses leakage of an electromagnetic field to the outside of the power transmitting module 400.

The power receiving module 500 may be similar in configuration to the power transmitting module 400. The power receiving module 500 includes: a reception coil 510; a communication electrode including two electrodes 520a and 520b functioning as differential transmission lines; a magnetic core 530; a communication circuit 540; and a housing 590 accommodating these. These component elements are similar in configuration to the corresponding component elements of the power transmitting module 400.

The reception coil 510, the two electrodes 520a and 520b, and the magnetic core 530 may have structures similar to the structures described in FIG. 7 and FIG. 8. The communication circuit 540 is connected to one end of each of the two electrodes 520a and 520b, to perform transmission or reception of two signals which are opposite in phase but equal in amplitude. The communication circuit 540 may be disposed in the housing 590 as shown in FIG. 6.

In the example of FIG. 6, the reception coil 510 is opposed to the transmission coil 410. The communication electrodes 520a and 520b on the power-receiving side are respectively opposed to the communication electrodes 420a and 420b on the power-transmitting side. The transmission coil 410 and the reception coil 510 perform power transmission via magnetic field coupling. The communication electrodes 420a and 420b and the communication electrodes 520a and 520b perform data transmission via coupling between the electrodes. Data transmission may be started from either one of the power transmitting module 400 and the power receiving module 500.

With the above configuration, between the power transmitting module 400 and the power receiving module 500, electric power and data can simultaneously be transmitted wirelessly. Although a differential transmission line pair is used in the above configuration, communication electrodes which perform single-ended transmission may alternatively be used.

The inventors have found a problem with the aforementioned configuration in that the dimension of the device along a perpendicular direction to the axis is increased by the fact that an antenna for power transmission purposes and a communication electrode flank each other along a perpendicular direction to the axis, thus making it different to realize a smaller radius. In applications to a joint of a robot device as shown in FIG. 1, smaller radii are required depending on where it is employed, which makes it difficult to adopt a structure as shown in FIG. 6 and FIG. 7.

Based on the above thoughts, the inventors have arrived at the configurations of embodiments of the present disclosure described below.

A wireless power and data transmission apparatus according to an embodiment of the present disclosure includes an inner module and an outer module. At least one of the inner module and the outer module is disposed so as to be capable of rotating around an axis. The inner module includes an annular-shaped first antenna disposed around the axis, and an annular-shaped first communication electrode disposed around the axis. The first communication electrode is at a different position from that of the first antenna regarding a direction along the axis. The outer module includes an annular-shaped second antenna disposed around the axis, the second antenna performing power transmission or power reception with the first antenna via magnetic field coupling or electric field coupling and an annular-shaped second communication electrode disposed around the axis. The second antenna performs power transmission or power reception with the first antenna via magnetic field coupling or electric field coupling. The second communication electrode is at a different position from that of the second antenna regarding the direction along the axis, and the second antenna performs communications with the first communication electrode via electric field coupling.

With the above configuration, regarding the direction along the axis, the first communication electrode is at a different position from that of the first antenna, and the second communication electrode is at a different position from that of the second antenna. In other words, the first antenna and the first communication electrode are not on the same plane, and also the second antenna and the second communication electrode are not on the same plane. With such a structure, the size of the device along a perpendicular direction to the axis can be reduced, thereby realizing an even smaller radius.

In the present specification, an “annular shape” refers to a shape that is schematically a circular shape. A slitted circular shape, such as a circular arc shape, is also encompassed within an annular shape.

One of the inner module and the outer module functions as a power transmitting module, whereas the other functions as a power receiving module. In the case where the inner module functions as a power transmitting module, the first antenna functions as a transmission antenna, while the second antenna functions as a reception antenna. Conversely, in the case where the outer module functions as a power transmitting module, the second antenna functions as a transmission antenna, while the first antenna functions as a reception antenna.

Each of the first antenna and the second antenna may be a coil to perform power transmission or power reception via magnetic field coupling, or an electrode or an electrode group to perform power transmission or power reception via electric field coupling. In the present specification, the term “antenna” is used as a notion encompassing a coil and an electrode or an electrode group that may be used for power transmission. A transmission antenna is connected to a power transmitting circuit that outputs AC power. A reception antenna converts received AC power into another form of AC power or DC power for use by a load.

Each of the first communication electrode and the second communication electrode may be configured to perform one or both of transmission and reception. In the case where the first communication electrode performs transmission, the second communication electrode performs reception. Conversely, in the case where the second communication electrode performs transmission, the first communication electrode performs transmission. Each of the power transmitting module and the power receiving module may include two communication electrodes, i.e., for transmission purposes and for reception purposes. In that case, full duplex communication may be achieved, where transmission from the power-transmitting side to the power-receiving side and transmission from the power-receiving side to the power-transmitting side are concurrently performed.

Each of the first communication electrode and the second communication electrode may include a differential transmission line pair as described above, for example. Alternatively, each of the first communication electrode and the second communication electrode may include one transmission line for performing single-ended transmission. Each communication electrode is connected to a respectively corresponding communication circuit (i.e., a transmission circuit or a reception circuit).

The diameter of the first communication electrode and the diameter of the first antenna may be equal or different. Similarly, the diameter of the second communication electrode and the diameter of the second antenna may be equal or different. In the latter case, when viewed in the direction along the axis, the position of the first communication electrode differs from the position of the first antenna, and the position of the second communication electrode differs from the position of the second antenna.

The inner module may further include a first electrically-conductive shield between the first antenna and the first communication electrode. The outer module may further include a second electrically-conductive shield between the second antenna and the second communication electrode.

By providing these electrically-conductive shields, the electromagnetic interference between each antenna and each communication electrode can be further reduced. Herein, “electromagnetic interference” means: interference due to a magnetic field; interference due to an electric field; or interference due to a combination thereof. By providing electrically-conductive shields, influences of a magnetic field or an electric field occurring from each antenna during power transmission that are exerted on the a signal voltage on each communication electrode can be reduced, whereby communication quality can be improved. Owing to the interference suppressing effect based on electrically-conductive shields, the distance between the first antenna and the first communication electrode and the distance between the second antenna and the second communication electrode may be shortened. Note that it may be only one of the inner module and the outer module that includes an electrically-conductive shield. Each of the first electrically-conductive shield and the second electrically-conductive shield has an annular shape, for example. Each of the first electrically-conductive shield and the second electrically-conductive shield may be disposed around the axis.

When viewed in the direction along the axis, a mid position between the first antenna and the second antenna may be different from a mid position between the first communication electrode and the second communication electrode. Furthermore, when viewed in the direction along the axis, at least one of the first electrically-conductive shield and the second electrically-conductive shield may overlap the mid position between the first antenna and the second antenna. With such configurations, the electromagnetic interference between each antenna and each communication electrode can be further suppressed.

Regarding the direction along the axis, the first electrically-conductive shield may be at a different position from a position of the second electrically-conductive shield. Furthermore, when viewed in the direction along the axis, the first electrically-conductive shield and the second electrically-conductive shield may partially overlap. Such configurations provide an improved shielding performance, thereby allowing the electromagnetic interference between each antenna and each communication electrode to be further suppressed.

In one embodiment, each module is structured so that sliding one of the inner module and the outer module in the direction along the axis allows the one of the inner module and the outer module to be attached or detached. With such a structure, assembly and detachment of the inner module and the outer module can be facilitated.

For example, in one embodiment, regarding the direction along the axis, the first electrically-conductive shield is located between the second electrically-conductive shield and one of the second antenna and the second communication electrode. Regarding the direction along the axis, the second electrically-conductive shield is located between the first electrically-conductive shield and one of the first communication electrode and the first antenna. In a cross section containing the axis, an outer peripheral edge of the first electrically-conductive shield may be is located inside of the one of the second antenna and the second communication electrode, and an inner peripheral edge of the second electrically-conductive shield may be located outside of the one of the first communication electrode and the first antenna. As used herein, the “inner peripheral edge” means a portion of the given member that is located the innermost, whereas the “outer peripheral edge” means a portion of the given member that is located the outermost. With such a structure, when the inner module or the outer module is slid along the axial direction, they can be easily detached or attached, without interfering with each other.

Furthermore, in a cross section containing the axis, the outer peripheral edge of the first electrically-conductive shield may be located outside of the inner peripheral edge of the second electrically-conductive shield. Such a structure can reconcile a high interference suppressing effect based on the overlap between the first electrically-conductive shield and the second electrically-conductive shield and the ease of attachment and detachment.

The wireless power and data transmission apparatus may further include an actuator to rotate the at least one of the inner module and the outer module around the axis. Such an actuator may have an electric motor and a mechanism to transmit the motive force of the electric motor to the inner module or the outer module, for example.

The wireless power and data transmission apparatus may further include: a power transmitting circuit that is connected to one of the first antenna and the second antenna to output AC power; and a power receiving circuit that is connected to the other of the first antenna and the second antenna to convert received AC power into another form of electric power.

The wireless power and data transmission apparatus may further include a first communication circuit that is connected to one of the first communication electrode and the second communication electrode; and a second communication circuit that is connected to the other of the first communication electrode and the second communication electrode.

The present disclosure also encompasses a transmission module for use as the inner module or the outer module in any of the above wireless power and data transmission apparatuses. The transmission module may include at least one of the actuator, the power transmitting circuit, the power receiving circuit, the first communication circuit, and the second communication circuit mentioned above.

The wireless power and data transmission apparatus may be used as a wireless power feeding unit in a robot arm apparatus as shown in FIG. 1, for example. The wireless power and data transmission apparatus is applicable to not only a robot arm apparatus, but also any apparatus that includes a rotary mechanism.

In the present specification, a “load” means any device that may operate with electric power. Examples of “loads” include devices such as motors, cameras (imaging devices), light sources, secondary batteries, and electronic circuits (e.g., power conversion circuits or microcontrollers). A device which includes a load and a circuit to control the load may be referred to as a “load device”.

Hereinafter, more specific embodiments of the present disclosure will be described. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, identical or similar constituent elements are denoted by identical reference numerals.

### Embodiments

A wireless power transmission data transmission apparatus according to an illustrative embodiment of the present disclosure will be described. The wireless power and data transmission apparatus may be used as a component element in an industrial robot that is used at a factory, a site of engineering work, etc., as shown in FIG. 1, for example. Although the wireless power and data transmission apparatus may also be used for other purposes, e.g., supplying power to electric automobiles, the present specification will mainly describe its applications to industrial robots.

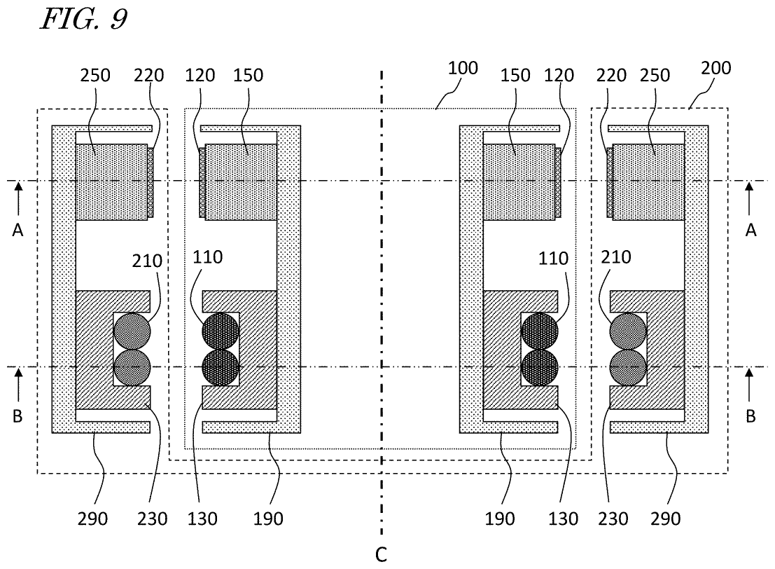

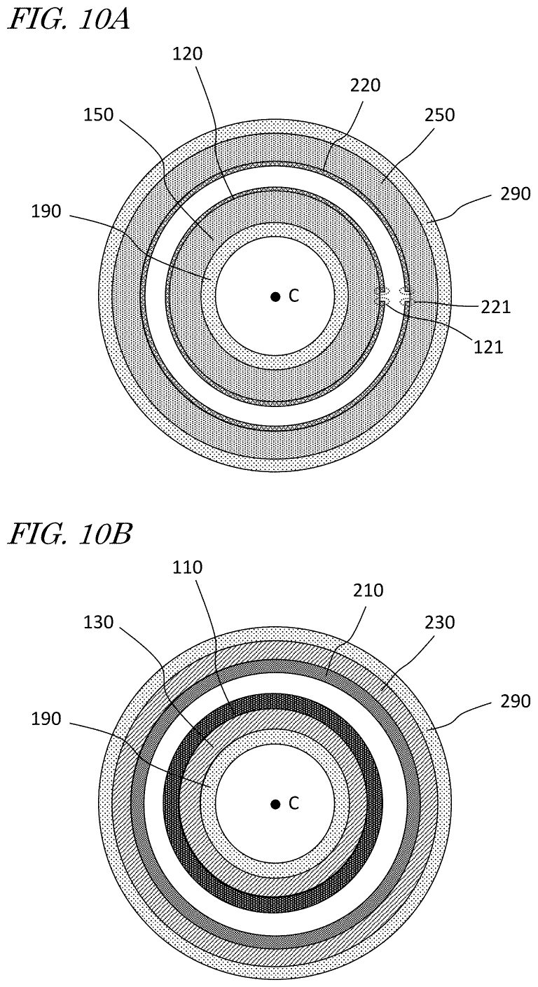

FIG. 9 is a cross-sectional view schematically showing an example configuration of a wireless power and data transmission apparatus according to an illustrative embodiment of the present disclosure. FIG. 9 shows an example of a cross-sectional structure of the wireless power and data transmission apparatus along a plane containing the axis C. FIG. 10A is a diagram showing the structure along a cross section taken along line B-B in FIG. 9. FIG. 10B is a diagram showing the structure along a cross section taken along line C-C in FIG. 9.

As shown in FIG. 9, the wireless power and data transmission apparatus includes an inner module 100 and an outer module 200. One or both of the inner module 100 and the outer module 200 is/are configured so as to be capable of rotating around the axis C by means of an actuator not shown. One of the inner module 100 and the outer module 200 functions as a power transmitting module. The other of the inner module 100 and the outer module 200 functions as a power receiving module. In the following description, an example will be described where the outer module 200 is a power transmitting module and the inner module 100 is a power receiving module. Conversely to this example, the inner module 100 may be a power transmitting module while the outer module 200 may be a power receiving module.

The inner module 100 includes a first antenna 110, a first communication electrode 120, a first magnetic core 130, and a dielectric member 150, as well as a metal housing 190 supporting these. The outer module 200 includes a second antenna 210, a second communication electrode 220, a second magnetic core 230, and a dielectric member 250, as well as a metal housing 290 supporting these. Although not shown in FIG. 9 to FIG. 10B, the inner module 100 may further include a power receiving circuit that is connected to the first antenna 110 and a first communication circuit that is connected to the first communication electrode 120. Similarly, the outer module 200 may further include a power transmitting circuit that is connected to the second antenna 210 and a second communication circuit that is connected to the second communication electrode 220.

Each of the first antenna 110 and the second antenna 210 in the present embodiment is an annular-shaped coil disposed around the axis C. For simplicity, FIG. 9 illustrates the coils as having two turns and one layer; however, the number of turns and the number of layers in each coil may be arbitrary. The second antenna 210 is located outside the first antenna 110. In the present embodiment, the first antenna 110 functions as a reception antenna, whereas the second antenna 210 functions as a transmission antenna. The transmission antenna is connected to a power transmitting circuit not shown. The power transmitting circuit supplies AC power to the transmission antenna. The reception antenna is connected to a power receiving circuit not shown. The power receiving circuit converts the AC power received by the reception antenna into another form of electric power required by a load such as a motor. During operation, the first antenna 110 and the second antenna 210 are magnetically coupled through electromagnetic induction. As a result, electric power is wirelessly transmitted from the first antenna 110 to the second antenna 210.

The first magnetic core 130 is an annular-shaped magnetic body having a dent on its outer periphery. The second magnetic core 230 is an annular-shaped magnetic body having a dent on its inner periphery. The first antenna 110 is accommodated in the dent of the first magnetic core 130, whereas the second antenna 210 is accommodated in the dent of the second magnetic core 230. The magnetic cores 130 and 230 are disposed so that the outer peripheral portion of the first antenna 110 and the inner peripheral portion of the second antenna 210 are opposed to each other.

Each of the first communication electrode 120 and the second communication electrode 220 in the present embodiment is an annular-shaped transmission line disposed around the axis C. As shown in FIG. 9, the first communication electrode 120 is at a position away from the first antenna 110 in a direction along the axis C. Similarly, the second communication electrode 220 is at a position away from the second antenna 210 in a direction along the axis C. In the present embodiment, the first communication electrode 120 is supported by the dielectric member 150, whereas the second communication electrode 220 is supported by the dielectric member 250. The first communication electrode 120 and the second communication electrode 220 are opposed to each other. A gap exists between the first communication electrode 120 and the second communication electrode 220, so that signals are transmitted via this gap. Even when the inner module 100 or the outer module 200 rotates around the axis C, the first communication electrode 120 and the second communication electrode 220 are kept opposed to each other.

The first communication electrode 120 is connected to a first communication circuit not shown. The second communication electrode 220 is connected to a second communication circuit not shown. Each of the first communication circuit and the second communication circuit may include a circuit element such as a modulation circuit or a demodulation circuit for performing signal transmission or reception.

As shown in FIG. 10A, the first communication electrode 120 has a slitted circular shape. One end 121 of the first communication electrode 120 is connected to a terminal of the first communication electrode. The other end of the first communication electrode 120 is terminated. Similarly, the second communication electrode 220 has a slitted circular shape. One end 221 of the second communication electrode 220 is connected to a terminal of the second communication electrode. The other end of the second communication electrode 220 is terminated. During signal transmission, a signal is input from one of the first communication circuit and the second communication circuit, and the signal is transmitted to the other of the first communication circuit and the second communication circuit via the communication electrodes 120 and 220. Signal transmission between the inner module 100 and the outer module 200 is thus realized.

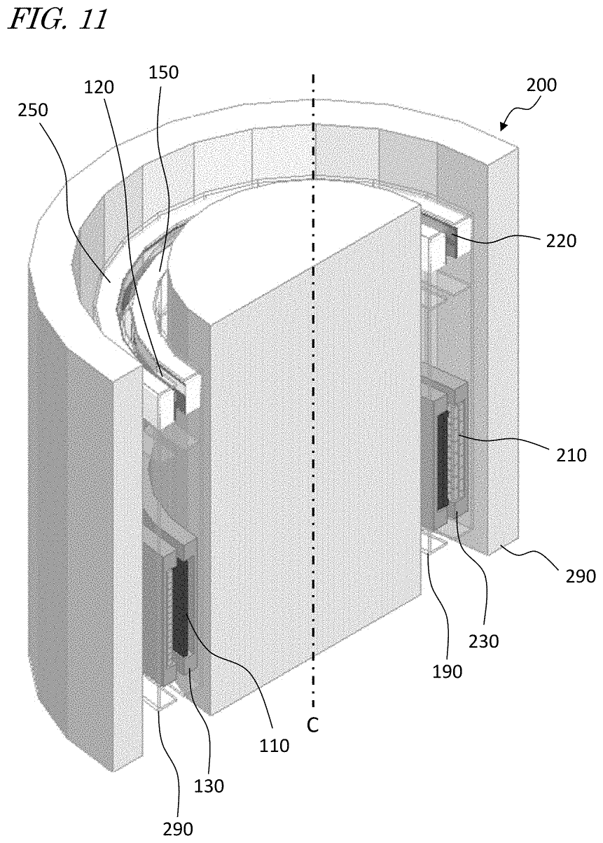

FIG. 11 is a perspective view showing an exemplary internal structure of the wireless power and data transmission apparatus when cut along a plane containing the axis C. In this example, each of the first antenna 110 and the second antenna 210 is a coil having 16 turns and 1 layer. As shown in the figure, the first antenna 110 and the second antenna 210 are in a concentric arrangement. A gap exists between the first antenna 110 and the second antenna 210. Similarly, the first communication electrode 120 and the second communication electrode 220 are in a concentric arrangement. A minute gap exists between the first communication electrode 120 and the second communication electrode 220.

The dimensions of each antenna 110, 210 and each communication electrode 120, 220 are not particularly limited. However, there may be cases where a hollow structure is needed for incorporation into a robot, for example, and they may be set to the following dimensions. The diameter of the first antenna 110 may be set to a value of e.g. not less than 67 mm and not more than 72 mm. The diameter of the second antenna 210 is greater than the diameter of the first antenna 110, and may be set to a value which is e.g. 93 mm or less. The diameter of the first communication electrode 120 may be set to a value of e.g. not less than 67 mm and not more than 72 mm. The diameter of the second communication electrode 220 is greater than the diameter of the first communication electrode 120, and may be set to a value which is e.g. 93 mm or less. The interval between the first antenna 110 and the second antenna 210 (i.e., the size of the gap along a perpendicular direction to the axis C) may be set to a value of e.g. not less than 1 mm and not more than 3 mm. The interval between the first communication electrode 120 and the second communication electrode 220 may be set to a value of e.g. not less than 1 mm and not more than 3 mm. However, the aforementioned numerical ranges are merely examples, and each dimension may be outside the respective numerical range.

In the example shown in FIG. 9, each of the first communication electrode 120 and the second communication electrode 220 includes a single transmission line that performs single-ended transmission. However, the present disclosure is not limited to this example. For example, the communication electrode of each module may include two transmission lines, i.e., a differential transmission line pair, that function as differential transmission lines.

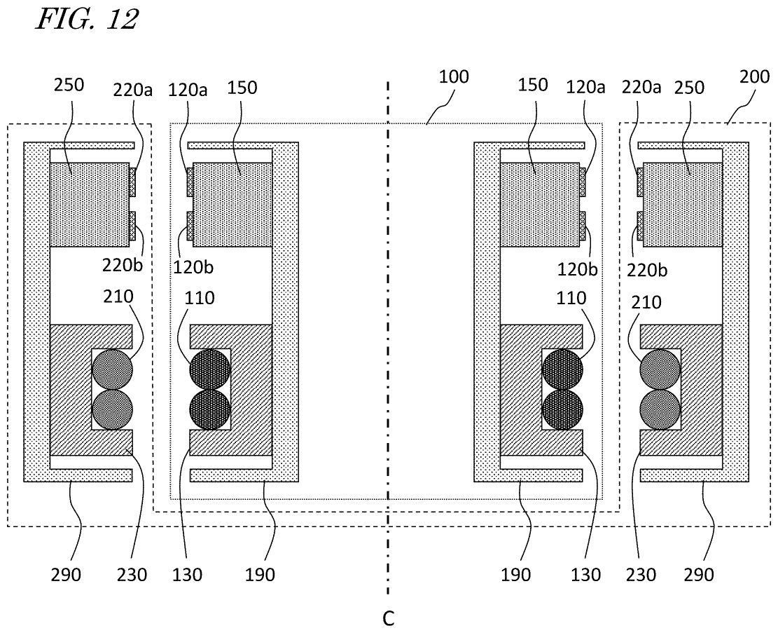

FIG. 12 is a cross-sectional view showing an exemplary configuration where each communication electrode includes a differential transmission line pair. In this example, the first communication electrode 120 includes two electrodes 120a and 120b constituting a differential transmission line pair. The second communication electrode 220 includes two electrodes 220a and 220b constituting a differential transmission line pair. The electrodes 120a and 120b are arranged in the direction along the axis C. Similarly, the electrodes 220a and 220b are arranged in the direction along the axis C. The electrodes 220a and 220b are respectively opposed to the electrodes 120a and 120b. The two electrodes 120a and 120b of the first communication electrode 120 are connected to a first communication circuit not shown. The two electrodes 220a and 220b of the second communication electrode 220 are connected to a second communication circuit not shown. When the first communication circuit performs transmission, the first communication circuit supplies two signals of mutually opposite phases (hereinafter referred to as “differential signals”) respectively to the two electrodes 120a and 120b of the first communication electrode 120. The differential signals are transmitted from the electrodes 120a and 120b to the electrodes 220a and 220b, and received by the second communication circuit. Through processing including differential arithmetics of the received signals, the second communication circuit is able to demodulate the transmitted signal.

In the case where differential transmission is employed as in the example of FIG. 12, influences of electromagnetic noises are counteracted, whereby communication quality can be improved.

Next, other exemplary configurations for the wireless power and data transmission apparatus will be described.

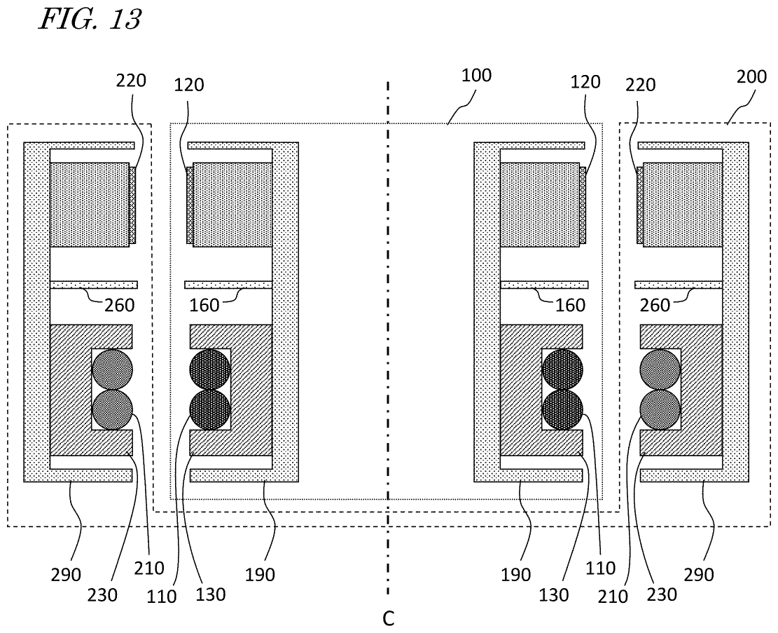

FIG. 13 is a cross-sectional view showing an example of a wireless power and data transmission apparatus that includes a plurality of electrically-conductive shields. In this example, the inner module 100 includes a first electrically-conductive shield 160 between the first antenna 110 and the first communication electrode 120. The outer module 200 further includes a second electrically-conductive shield 260 between the second antenna 210 and the second communication electrode 220. Each of the first electrically-conductive shield 160 and the second electrically-conductive shield 260 has an annular shape, and is disposed around the axis C. The first electrically-conductive shield 160 and the second electrically-conductive shield 260 are disposed on the same plane. Each electrically-conductive shield 160, 260 is a plate of metal, for example. As in this example, by disposing the electrically-conductive shields 160 and 260, influences of electromagnetic fields occurring from the antennas 110 and 210 during power transmission on the signals transmitted between the communication electrodes 120 and 220 can be reduced. This may allow the coils 110 and 210 and the communication electrodes 120 and 220 to be disposed at shorter intervals, for example.

The electrically-conductive shields do not need to be plate-shaped, but may have any shape.

Each electrically-conductive shield may be made of a metal such as copper or aluminum, for example. Otherwise, the following configurations may be employed as electrically-conductive shields or alternatives thereof.
a configuration obtained by coating side walls made of an electrical insulator with an electrically conductive paint (e.g., a silver paint or a copper paint)
a configuration obtained by attaching an electrically conductive tape (e.g., a copper tape or an aluminum tape) on side walls made of an electrical insulator
an electrically conductive plastic (i.e., a material including a metal filler kneaded in a plastic)

Any of these may exhibit a similar function to that of the aforementioned electrically-conductive shield. Such configurations will collectively be referred to as “electrically-conductive shields”.

Each electrically-conductive shield according to the present embodiment has a ring structure that conforms along the antennas 110 and 210 and the communication electrodes 120 and 220. Each electrically-conductive shield may have a structure with a gap to create a C shape (i.e., a circular arc shape), as does each communication electrode 120, 220. In that case, too, losses of energy due to an eddy current can be reduced. Each electrically-conductive shield may have a polygonal or elliptical shape, for example. A plurality of metal plates may be placed together to compose a shield. Furthermore, each electrically-conductive shield may have one or more apertures or slits. Such a configuration allows losses of energy due to an eddy current to be reduced.

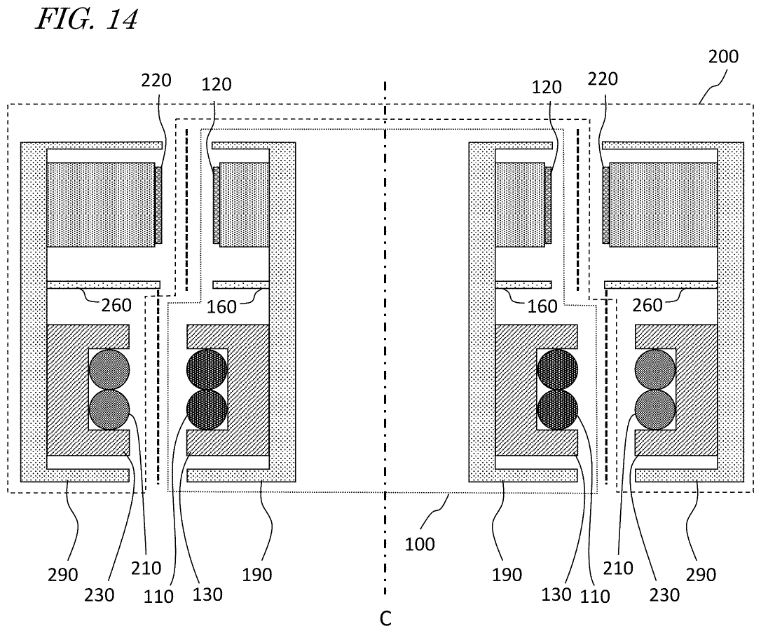

FIG. 14 is a cross-sectional view showing another example of a wireless power and data transmission apparatus that includes a plurality of electrically-conductive shields. In this example, the diameter of the first communication electrode 120 differs from the diameter of the first antenna 110, and the diameter of the second communication electrode 220 differs from the diameter of the second antenna 210. Herein, the diameter of the first antenna 110, or the diameter of the first communication electrode 120, means the diameter of a circle that is defined by the outer peripheral edge of each. On the other hand, the diameter of the second antenna 210, or the diameter of the second communication electrode 220, means the diameter of a circle that is defined by the inner peripheral edge of each. In this example, the width of the second electrically-conductive shield 260 is greater than the width of the first electrically-conductive shield 160. When viewed from the direction along the axis C, the mid position between the first antenna 110 and the second antenna 210 (i.e., the position of an upper thick broken line in FIG. 14) differs from the mid position between the first communication electrode 120 and the second communication electrode 220 (i.e., the position of a lower thick broken line in FIG. 14). Moreover, when viewed from the direction along the axis C, the second electrically-conductive shield 260 overlaps the mid position between the first antenna 110 and the second antenna 210. In other words, the inner peripheral edge of the second electrically-conductive shield 260 is inside of the mid position between the antennas 11 and 210. Contrary to this example, the width of the first electrically-conductive shield 160 may be greater than the width of the second electrically-conductive shield 260. In that case, the outer peripheral edge of the first electrically-conductive shield 160 may be located outside of the mid position between the antennas 110 and 210. As in this example, the mid position between the antennas and the mid position between the communication electrodes may be shifted, whereby the interference suppressing effect can be further enhanced.

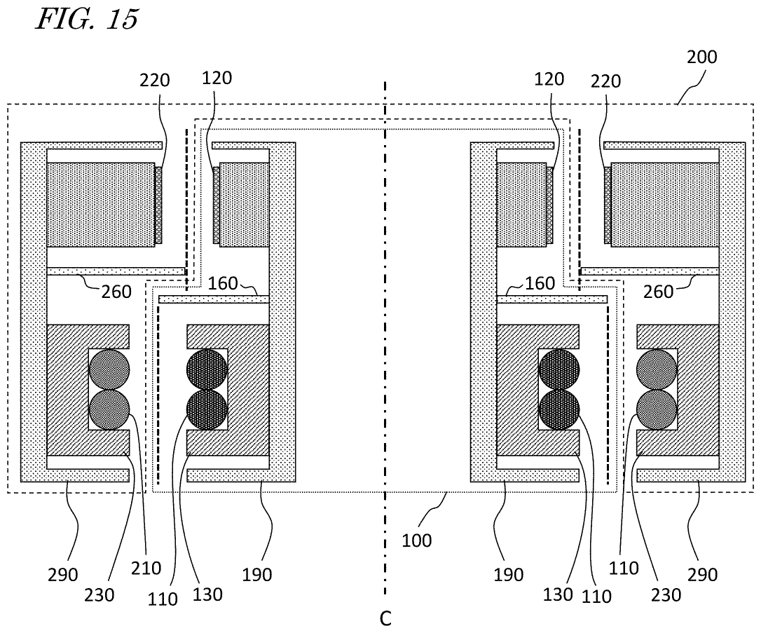

FIG. 15 is a cross-sectional view showing still another example of a wireless power and data transmission apparatus that includes a plurality of electrically-conductive shields. In this example, regarding the direction along the axis C, the position of the first electrically-conductive shield 160 differs from the position of the second electrically-conductive shield 260. When viewed from the direction along the axis C, the first electrically-conductive shield 160 and the second electrically-conductive shield 260 partially overlap. The outer peripheral edge of the first electrically-conductive shield 160 is outside of the mid position between the communication electrodes 120 and 220, and reaches over to the mid position between the antennas 110 and 210. The inner peripheral edge of the second electrically-conductive shield 260 is inside of the mid position between the antennas 110 and 210, and reaches over to the mid position between the communication electrodes 120 and 220. The outer peripheral edge of the first electrically-conductive shield 160 may be outside or inside of the mid position between the antennas 110 and 210. The inner peripheral edge of the second electrically-conductive shield 260 may be inside or outside of the mid position between the communication electrodes 120 and 220. As in the example of FIG. 15, by disposing the plurality of shields 160 and 260 so as to overlap each other, the interference suppressing effect can be further enhanced.

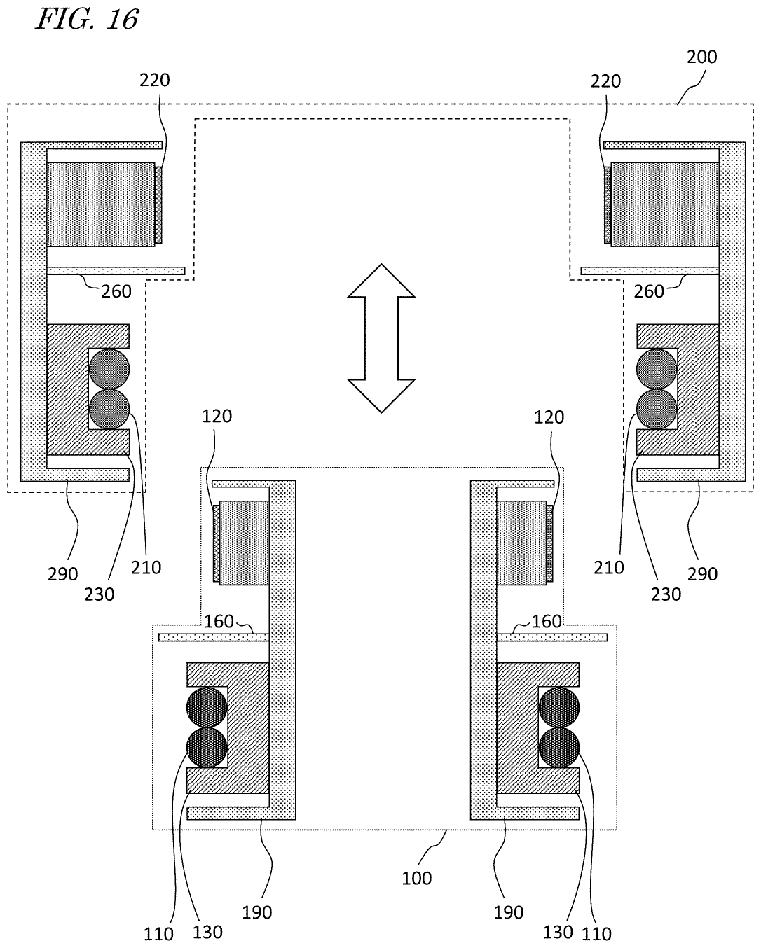

The structure shown in FIG. 15 is characterized in that, although the electrically-conductive shields 160 and 260 protrude from any other portion in this structure, it permits easy assembly and detachment. In this example, regarding the direction along the axis C, the first electrically-conductive shield 160 is located between the second electrically-conductive shield 260 and the second antenna 210. Regarding the direction along the axis C, the second electrically-conductive shield 260 is located between the first electrically-conductive shield 160 and the first communication electrode 120. The outer peripheral edge of the first electrically-conductive shield 160 is outside of the inner peripheral edge of the second electrically-conductive shield 260 and yet inside of the second antenna 210 and the second magnetic core 230. Moreover, the inner peripheral edge of the second electrically-conductive shield 260 is outside of the first communication electrode 120. With such a structure, even if the inner module 100 or the outer module 200 is slid in the direction along the axis C, each electrically-conductive shield 160, 260 will not interfere with any other member. Therefore, as shown in FIG. 16, by sliding one of the inner module 100 and the outer module 200 in the direction along the axis C, the module can be easily attached or detached. In the present specification, as shown in FIG. 16, a structure that permits easy assembly without allowing interference between members may be referred to as a “nesting structure”.

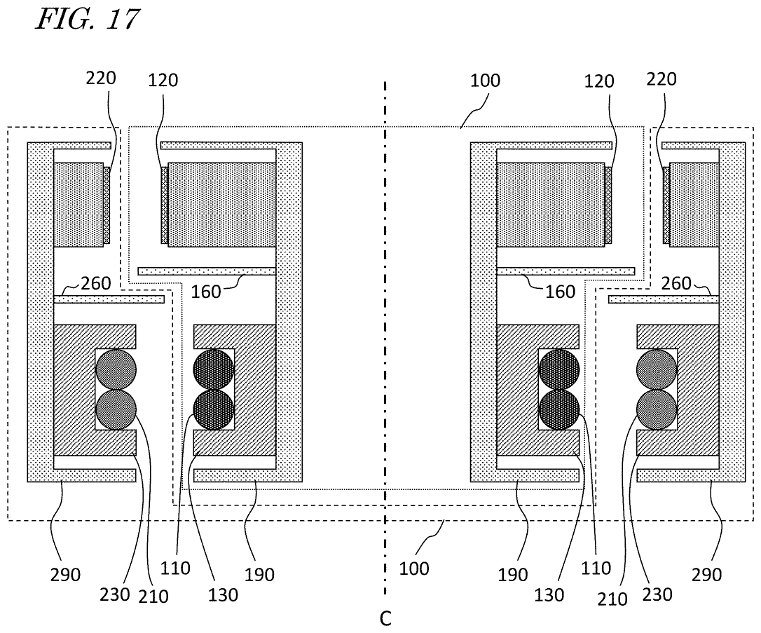

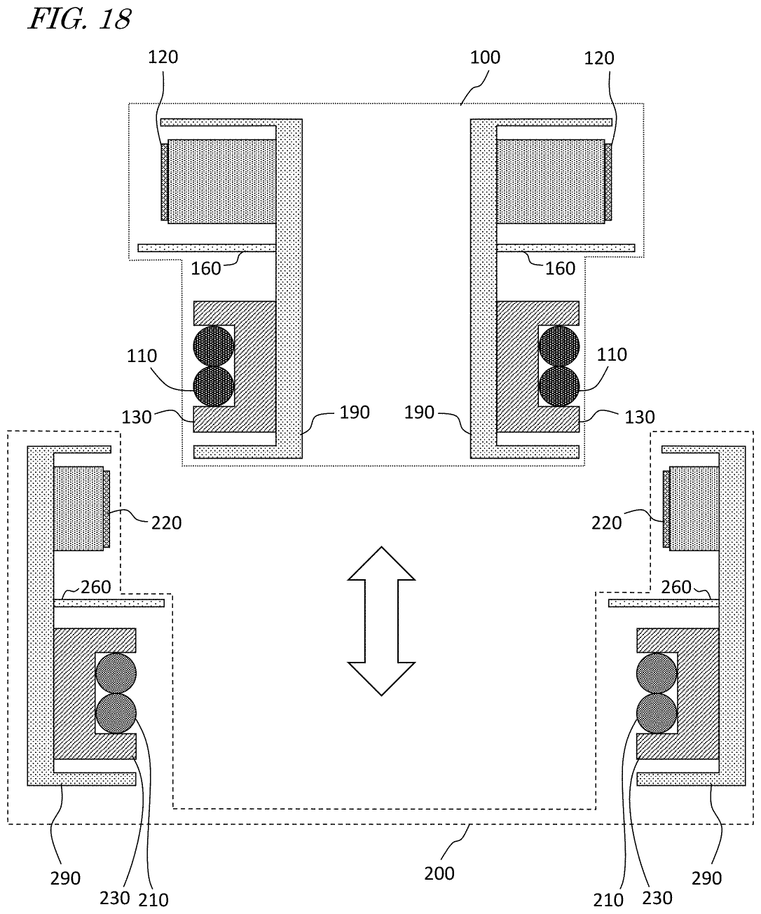

FIG. 17 is a diagram showing another example of a wireless power and data transmission apparatus having a nesting structure. In this example, contrary to the example of FIG. 15, the diameter of the first communication electrode 120 is greater than the diameter of the first antenna 110, the diameter of the second communication electrode 220 is greater than the diameter of the second antenna 210, and the width of the first electrically-conductive shield 160 is greater than the width of the second electrically-conductive shield 260. In this example, regarding the direction along the axis C, the first electrically-conductive shield 160 is located between the second electrically-conductive shield 260 and the second communication electrode 220. Regarding the direction along the axis C, the second electrically-conductive shield 260 is located between the first electrically-conductive shield 160 and the first antenna 110. The outer peripheral edge of the first electrically-conductive shield 160 is outside of the inner peripheral edge of the second electrically-conductive shield 260 and yet inside of the second communication electrode 220. Moreover, the inner peripheral edge of the second electrically-conductive shield 260 is outside of the first antenna 110. With such a structure, too, even if the inner module 100 or the outer module 200 is slid in the direction along the axis C, each electrically-conductive shield 160, 260 will not interfere with any other member. Therefore, as shown in FIG. 18, the inner module 100 and the outer module 200 can be easily assembled or disassemble.

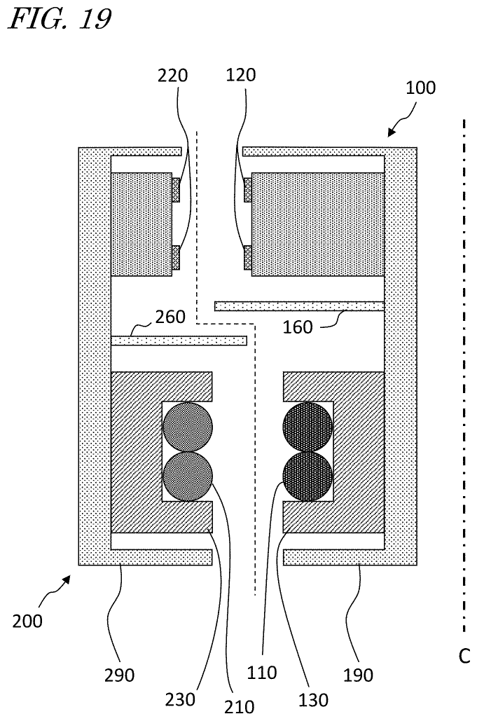

In each example described with reference to FIG. 13 to FIG. 18, each of the communication electrodes 120 and 220 may be composed of a differential transmission line pair as in the example of FIG. 12. FIG. 19 shows one example where the configuration shown in FIG. 17 is adapted so that the communication electrodes 120 and 220 are composed of differential transmission line pairs. Note that FIG. 19 and any subsequent cross-sectional view illustrates, within the wireless power and data transmission apparatus, only a portion on one side of the axis C. Utilizing differential transmission allows for reducing signal noise and improve communication quality.

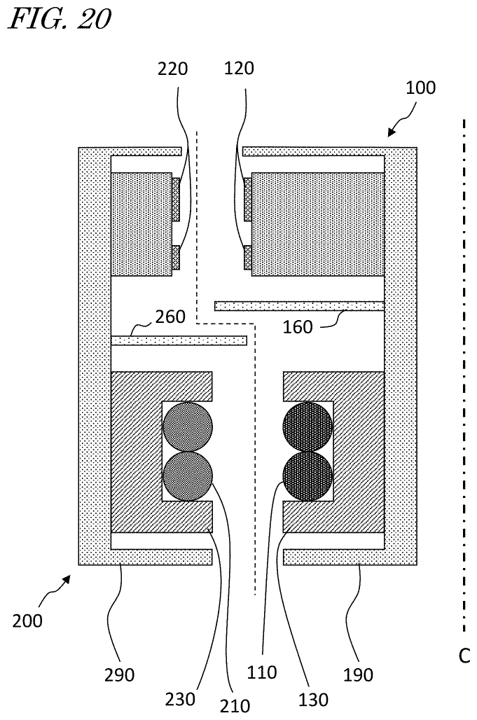

FIG. 20 is a cross-sectional view showing another variant of the wireless power and data transmission apparatus. In this example, each of the communication electrodes 120 and 220 includes two differential transmission lines of different widths. The transmission lines that are closer to the antennas 110 and 210 have a smaller width than the width of the transmission lines that are farther from the antennas 110 and 210. By thus differentiating the two transmission lines in width or area, the level of noise influences on the signal in each line that is associated with wireless power transmission can be adjusted. As a result, the effect of noise suppression based on differential lines can be further improved.

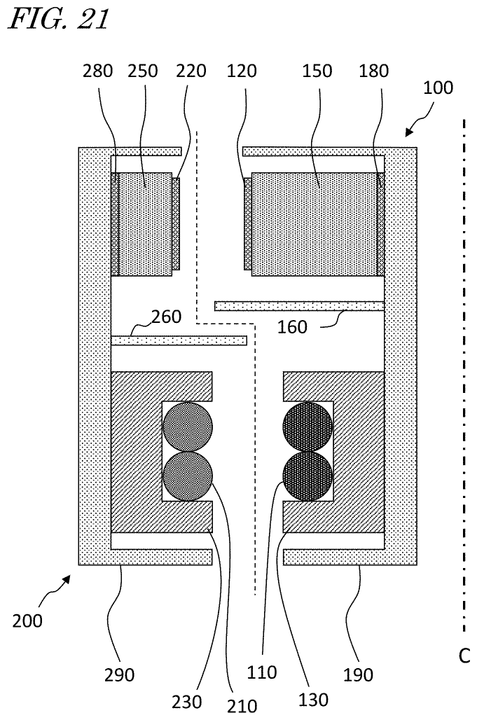

FIG. 21 is a cross-sectional view showing another variant of the wireless power and data transmission apparatus. In this example, an electrically conductive member 180 is disposed between the dielectric member 150 and the metal housing 190 of the inner module 100. Similarly, an electrically conductive member 280 is disposed between the dielectric member 250 and the metal housing 290 of the outer module 200. Similarly to the communication electrodes 120 and 220, the electrically conductive members 180 and 280 have an annular plate structure. The communication electrode 120 and the electrically conductive member 180 are located on opposite sides of the dielectric member 150. Similarly, the communication electrode 220 and the electrically conductive member 280 are located on opposite sides of the dielectric member 250. The electrically conductive members 180 and 280 are grounded, so that influences of the metal housings 190 and 290 on the signals on the communication electrodes 120 and 220 are alleviated. Such electrically conductive members 180 and 280 may be referred to as “rear-face GND”. Such electrically conductive members 180 and 280 may also be similarly provided in any other embodiment than FIG. 21 of the present disclosure.

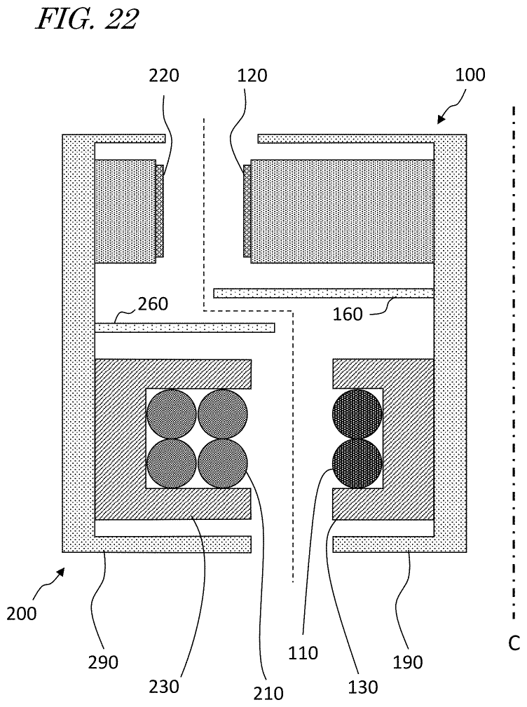

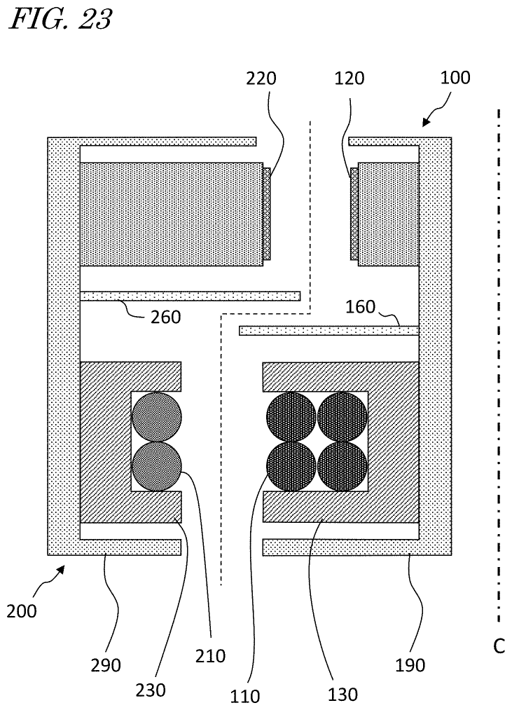

FIG. 22 is a cross-sectional view showing still another variant of the wireless power and data transmission apparatus. In this example, the first antenna 110 and the second antenna 210 differ from each other in terms of the number of turns in the coil. In the example shown in FIG. 22, the outer coil has more turns than does the inner coil. Conversely to this example, as shown in FIG. 23, for example, the inner coil may have more turns than does the outer coil. Such a structure may be adopted when stepping up or stepping down through wireless power transmission. Rather than in terms of the number of turns, the thickness or material of the windings may be made asymmetric between the power-transmitting side and the power-receiving side.

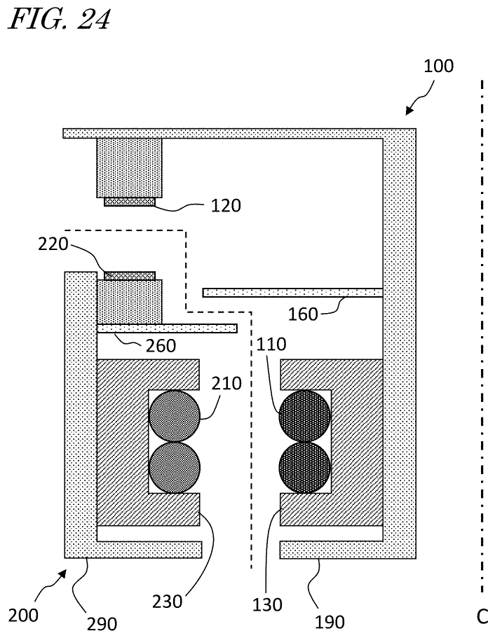

In each of the above examples, the communication electrodes 120 and 220 are on the same plane that is perpendicular to the axis C, and mutually opposing faces of the communication electrodes 120 and 220 are parallel to the axis C. The present disclosure is not limited to this positioning. In other words, the mutually opposing faces of communication electrodes 120 and 220 may be inclined from the direction of axis C. For example, as shown in FIG. 24, the positioning of the communication electrodes 120 and 220 may be rotated by 90° from the aforementioned positioning. In this example, normal directions of the mutually opposing faces of the communication electrodes 120 and 220 are parallel to the axis C. Moreover, both of the communication electrodes 120 and 220 are located outside of the second antenna 210. With such positioning, noise on the signals associated with electromagnetic fields occurring from the antennas 110 and 210 can be further reduced.

In each of the above examples, only one pair of communication electrodes 120 and 220 is provided. Therefore, bidirectional communication is only possible by way of half duplex communication, where each communication electrode 120, 220 alternatively performs transmission or reception. Alternatively, two or more pairs of communication electrodes 120 and 220 may be provided; in that case, full duplex communication becomes possible, that is, transmission from both sides may concurrently occur.

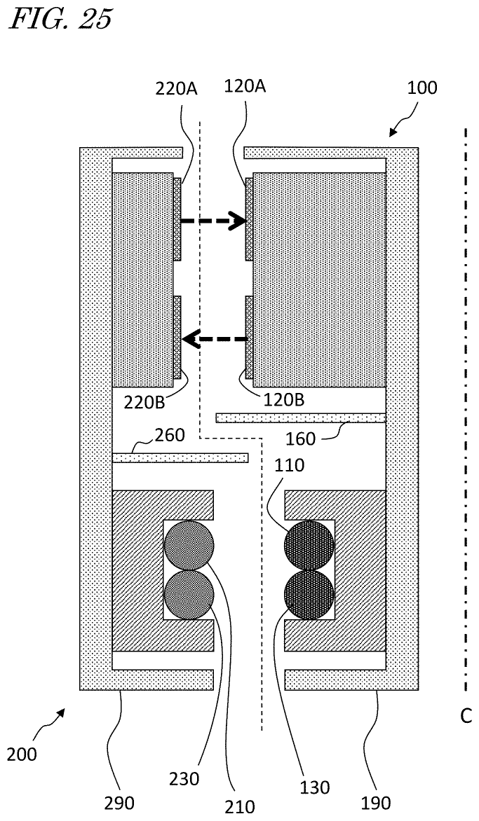

FIG. 25 is a diagram showing an example of a wireless power and data transmission apparatus that is capable of full duplex communication. Broken line arrows in FIG. 25 schematically represent directions of communication at a given moment. In this example, the inner module 100 includes two communication electrodes 120A and 120B, whereas the outer module 200 includes two communication electrodes 220A, and 220B. The inner communication electrodes 120A and 120B are arranged in the direction along the axis C, and the outer communication electrodes 220A and 220B are also arranged in the direction along the axis C. The inner communication electrodes 120A and 120B are respectively opposed to the outer communication electrodes 220A and 220B. With such a structure, each module is able to concurrently perform transmission and reception, whereby full duplex communication can be realized.

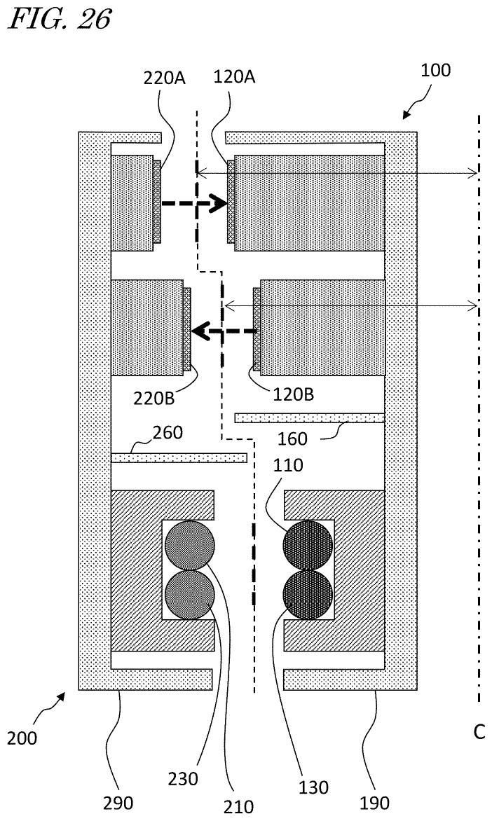

FIG. 26 is a diagram showing another example of a wireless power and data transmission apparatus that is capable of full duplex communication. In this example, distance from the axis C (indicated by both arrows in FIG. 26) differs between the pair of communication electrodes 120B and 220B that are relatively close to the antennas 110 and 210 and the pair of communication electrodes 120A and 220A that are relatively far from the antennas 110 and 210. The mid position between the communication electrodes 120B and 220B is outside of the mid position between the antennas 110 and 210, whereas the mid position between the communication electrodes 120A and 220A is outside of the mid position between the communication electrodes 120B and 220B. As in this example, the distance from the axis C may be varied from electrode pair to electrode pair. By doing so, the path length of each electrode can be adjusted to an appropriate length, and the noise on the transmitted signal can be further reduced.

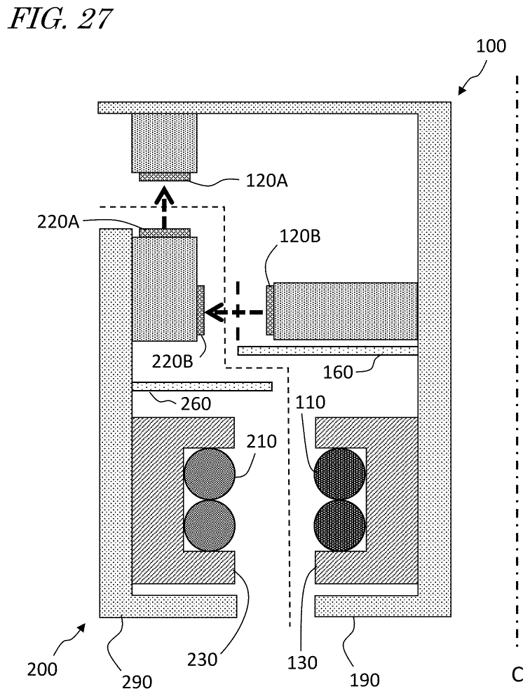

FIG. 27 is a diagram showing still another example of a wireless power and data transmission apparatus that is capable of full duplex communication. In this example, the orientations of the two communication electrodes 120A and 120B in the inner module 100 differ by 90°, and the orientations of the two communication electrodes 220A and 220B in the outer module 200 also differ by 90°. The communication electrodes 120 and 220 that are relatively close to the antennas 110 and 210 (referred to as the “first electrode pair”) are disposed so that their normal directions coincide with a perpendicular direction to the axis C. The communication electrodes 120 and 220 that are relatively far from the antennas 110 and 210 (referred to as the “second electrode pair”) are disposed so that their normal directions are oriented in a parallel direction to the axis C. With such positioning, crosstalk between the signals to be transmitted between the first electrode pair and the signals to be transmitted between the second electrode pair can be suppressed. In this example, the mid position between the first electrode pair is outside of the first antenna 110 and inside of the second antenna 210. The second electrode pair is outside of the second antenna 210. Without being limited to such positioning, the positioning of the electrode pairs may be arbitrarily selected.

In each of the above examples, each of the inner module 100 and the outer module 200 includes only one antenna for power transmission purposes. Without being limited to such a configuration, each module may include two or more antennas. For example, a plurality of antennas corresponding to electric powers of different magnitude may be mounted on each module.

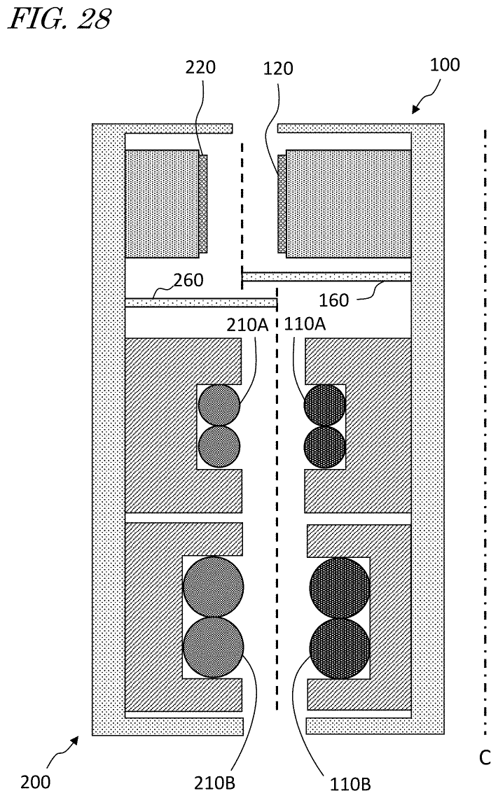

FIG. 28 is a diagram showing an example where each module includes two antennas for power transmission purposes. In this example, the inner module 100 includes two antennas 110A and 110B, whereas the outer module 200 includes two antennas 210A and 210B. The inner two antennas 110A and 110B are arranged in the direction along the axis C. The coil of the antenna 110B that is relatively far from the communication electrodes 120 and 220 has a cross-sectional area which is greater than the cross-sectional area of the coil of the antenna 110A that is relatively close to the communication electrodes 120 and 220. Similarly, the outer antennas 210A and 210B are arranged in the direction along the axis C. The coil of the antenna 210B has a cross-sectional area which is greater than the cross-sectional area of the coil of the antenna 210A. The antennas 110A and 210A are used for the purpose of transmitting a relatively small electric power. The antennas 110B and 210B are used for the purpose of transmitting a relatively large electric power. In this example, when viewed from the direction along the axis C, the mid position between the antennas 110A and 210A coincides with the mid position between the antennas 110B and 210B. On the other hand, the mid position between the electrodes 120 and 220 differs from the mid position between the antennas 110A and 210A and from the mid position between antennas 110B and 210B. In this example, the antennas 110A and 210A for transmitting a small electric power are disposed closer to the communication electrodes 120 and 220 than are the antennas 110B and 210B for transmitting a large electric power. Such a structure allows for suppressing the noise that is mixed in the signal that is being exchanged during power transmission.

FIG. 29 is a diagram showing another example where each module includes two antennas for power transmission purposes. In this example, the mid position between the antennas 110A and 210A and the mid position between the antennas 110B and 210B as viewed from the direction along the axis C differ from each other. The mid position between the former is outside of the mid position between the latter, and the mid position between the communication electrodes 120 and 220 is located further outside. As in this example, the gap position may differ among the respective pairs, i.e., the antennas 110A and 210A, the antennas 110B and 210B, and the communication electrodes 120 and 220. Such a structure allows for further suppressing the noise that is mixed into the signals to be exchanged between the communication electrodes.

The configuration of each of the above examples is only an example, and the present disclosure is not limited to these configurations. For example, in the examples illustrated in FIG. 13 to FIG. 29, the number of electrically-conductive shields is not limited to two, but may be 0, 1, or 3 or more. The positioning of the electrically-conductive shields is not limited to the illustrated positioning, either; their positioning may be changed depending on the required shielding property. Each antenna is not limited to a coil, and any electrode pair that performs wireless power transmission or power reception of electric power via e.g. electric field coupling (or capacitive coupling) may be utilized as an antenna. In such a configuration, the electrode pair of each antenna may be disposed in a manner similar to the communication electrodes. As the electrodes for power transmission purposes, electrodes which are larger in width or area than the electrodes (transmission lines) for communications purposes may be used. Furthermore, among the above-described examples, in any example where each communication electrode is a transmission line (electrode) for single-ended transmission, a differential transmission line pair (electrode pair) may be used instead. Conversely, in any example where each communication electrode is a differential transmission line pair (electrode pair), a transmission line for single-ended transmission may be used instead. In each of the above-described examples, the structures of the metal housings 190 and 290, the magnetic cores 130 and 230, and the dielectric members 150 and 250 are merely examples; depending on the required characteristics, their configuration may be altered.

Next, examples of the configuration and connection of the communication electrodes and communication circuits will be described more specifically.

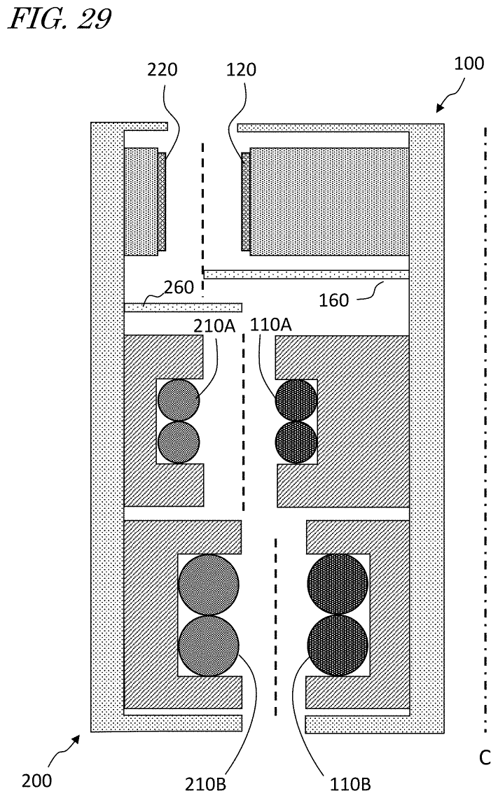

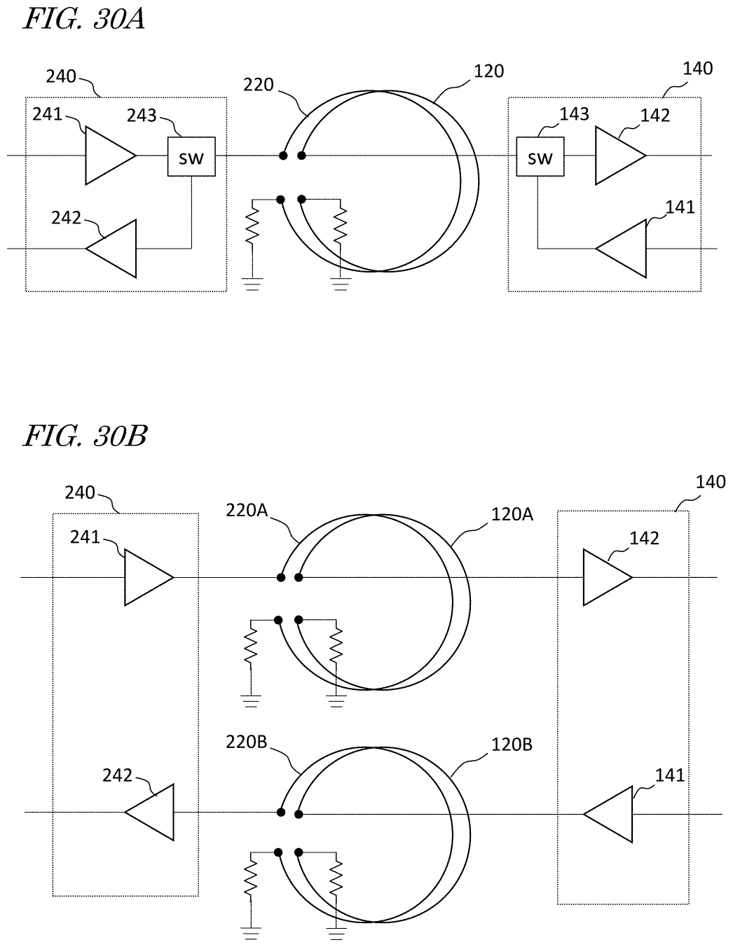

FIG. 30A is a diagram schematically showing an exemplary configuration of the communication electrodes and communication circuits in the case where half duplex communication via single-ended transmission is to be performed. The inner module 100 includes a first communication circuit 140 that is connected to the first communication electrode 120. The outer module 200 includes a second communication circuit 240 that is connected to the second communication electrode 220. The first communication circuit 140 includes a transmission circuit 141, a reception circuit 142, and a switch (SW) 143. The switch 143 is connected to one end of the first communication electrode 120. The switch 143 is also connected to the transmission circuit 141 and the reception circuit 142. In response to a control signal from a first control circuit not shown, the switch 143 is able to switch between a state where one end of the communication electrode 120 and the transmission circuit 141 are electrically connected and a state where the other end of the communication electrode 120 and the reception circuit 142 are electrically connected. The other end of the communication electrode 120 is grounded via a resistor. The second communication circuit 240 includes a transmission circuit 241, a reception circuit 242, and a switch 243. The switch 243 is connected to one end of the second communication electrode 220. The switch 243 is also connected to the transmission circuit 241 and the reception circuit 242. In response to a control signal from a second control circuit not shown, the switch 243 is able to switch between a state where one end of the communication electrode 220 and the transmission circuit 241 are electrically connected and a state where the other end of the communication electrode 220 and the reception circuit 242 are electrically connected. The other end of the communication electrode 220 is grounded via a resistor. Each control circuit may be a circuit including a processor, e.g., a microcontroller. When transmitting a signal from the inner module 100 to the outer module 200, the switch 143 electrically connects the transmission circuit 141 and the communication electrode 120, and the switch 243 electrically connects the reception circuit 242 and the communication electrode 220. Conversely, when transmitting a signal from the outer module 200 to the inner module 100, the switch 243 electrically connects the transmission circuit 241 and the communication electrode 220, and the switch 143 electrically connects the reception circuit 142 and the communication electrode 120. Such a configuration can achieve half duplex communication via single-ended transmission.

FIG. 30B is a diagram schematically showing an exemplary configuration of the communication electrodes and communication circuits in the case where full duplex communication via single-ended transmission is to be performed. In this example, the communication circuit 140 of the inner module 100 is connected to the two communication electrodes 120A and 120B of the inner module 100. The communication circuit 240 of the outer module 200 is connected to the two communication electrodes 220A and 220B of the outer module. The communication circuit 140 of the inner module includes a transmission circuit 141 that is connected to the communication electrode 120B and a reception circuit 142 that is connected to the communication electrode 120A. The communication circuit 240 of the outer module 200 includes a transmission circuit 241 that is connected to the communication electrode 220A, and a reception circuit 242 that is connected to the communication electrode 120B. In this example, each of the communication circuits 140 and 240 does not include a switch. When transmitting a signal from the inner module 100 to the outer module 200, the transmission circuit 141 inputs the signal to the communication electrode 120B, and the reception circuit 242 receives the signal having been transmitted via the communication electrodes 120B and 220B. Conversely, when transmitting a signal from the outer module 200 to the inner module 100, the transmission circuit 241 inputs the signal to the communication electrode 220A, and the reception circuit 142 receives the signal having been transmitted via the communication electrodes 220A and 120A. The operation of the transmission circuit 141 and the reception circuit 142 is controlled by a first control circuit not shown, whereas the operation of the transmission circuit 241 and the reception circuit 242 is controlled by a second control circuit not shown. Such a configuration can achieve full duplex communication via single-ended transmission.

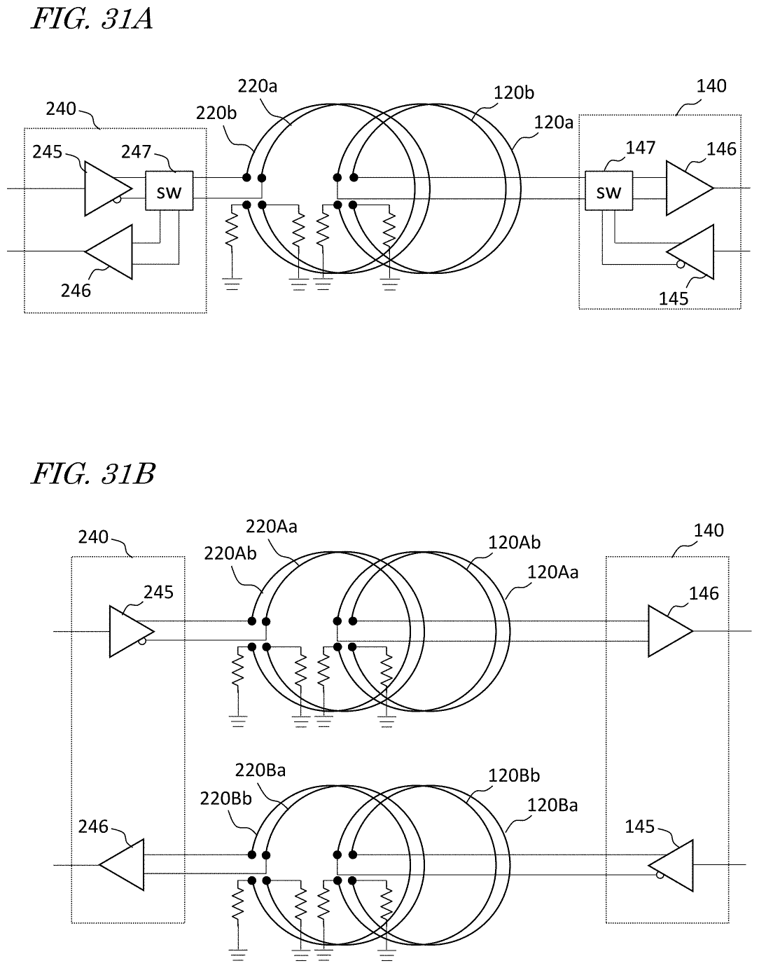

FIG. 31A is a diagram schematically showing an exemplary configuration of the communication electrodes and communication circuits in the case where half duplex communication via differential transmission is to be performed. In this example, the communication circuit 140 of the inner module 100 includes a transmission circuit 145 and a reception circuit 146 for differential transmission purposes, and a switch 147. The communication circuit 240 of the outer module 200 includes a transmission circuit 245 and a reception circuit 246 for differential transmission purposes, and a switch 247. In response to a control signal from a first control circuit not shown, the switch 147 switches between a state where the communication electrodes 120a and 120b and the transmission circuit 145 are connected and a state where the communication electrodes 120a and 120b and the reception circuit 146 are connected. In response to a control signal from a second control circuit not shown, the switch 247 switches between a state where the communication electrodes 220a and 220b and the transmission circuit 245 are connected and a state where the communication electrodes 220a and 220b and the reception circuit 246 are connected. The transmission circuits 145 and 245 each output differential signals from two terminals thereof. The reception circuits 246 and 246 each perform necessary processing, e.g., differential arithmetics, to the differential signals having been input to their respective two terminals, to demodulate a signal therefrom. Via the switch 147, one end of the communication electrodes 120a and 120b is connected to the two terminals of the transmission circuit 145 or to the two terminals of the reception circuit 146. The other end of the communication electrodes 120a and 120b is grounded via a resistor. Similarly, via the switch 247, one end of the communication electrodes 220a and 220b is connected to the two terminals of the transmission circuit 245 or to the two terminals of the reception circuit 246. The other end of the communication electrodes 220a and 220b is grounded via a resistor. When transmitting a signal from the inner module 100 to the outer module 200, the switch 147 electrically connects the transmission circuit 145 and the communication electrodes 120a and 120b, and the switch 247 electrically connects the reception circuit 246 and the communication electrodes 220a and 220b. Conversely, when transmitting a signal from the outer module 200 to the inner module 100, the switch 247 electrically connects the transmission circuit 245 and the communication electrodes 220a and 220b, and the switch 147 electrically connects the reception circuit 146 and the communication electrodes 120a and 120b. Such a structure can achieve half duplex communication via differential transmission.

FIG. 31B is a diagram schematically showing an exemplary configuration of the communication electrodes and communication circuits in the case where full duplex communication based on differential signals is to be performed. In this example, the inner module 100 includes a pair of communication electrodes 120Aa and 120Ab, which constitute a differential transmission line pair, and a pair of communication electrodes 120Ba and 120Bb, which constitute another differential transmission line pair. The outer module 200 includes a pair of communication electrodes 220Aa and 220Ab, which constitute a differential transmission line pair, and a pair of communication electrodes 220Ba and 220Bb, which constitute another differential transmission line pair. The communication electrodes 120Aa and 120Ab are respectively opposed to the communication electrodes 220Aa and 220Ab. The communication electrodes 120Ba and 120Bb are respectively opposed to the communication electrodes 220Ba and 220Bb. The communication circuit 140 of the inner module 100 includes a transmission circuit 145 and a reception circuit 146 for differential transmission purposes, but does not include a switch. The communication circuit 240 of the outer module 200 includes a transmission circuit 245 and a reception circuit 246 for differential transmission purposes, but does not include a switch. When transmitting a signal from the inner module 100 to the outer module 200, the transmission circuit 145 inputs differential signals to the communication electrodes 120Ba and 120Ba, and the reception circuit 242 demodulates the signal having been transmitted via the communication electrodes 120Ba, 120Bb, 220Ba and 220Bb. Conversely, when transmitting a signal from the outer module 200 to the inner module 100, the transmission circuit 245 inputs differential signals to the communication electrodes 220Aa and 220Ab, and the reception circuit 146 demodulates the signal having been transmitted via the communication electrodes 220Aa, 220Ab, 120Aa and 120Ab. The operation of the transmission circuit 145 and the reception circuit 146 is controlled by a first control circuit not shown, whereas the operation of the transmission circuit 245 and the reception circuit 246 is controlled by a second control circuit not shown. Such a configuration can achieve full duplex communication via differential transmission.

Now, example methods of terminating each differential transmission line will be described.

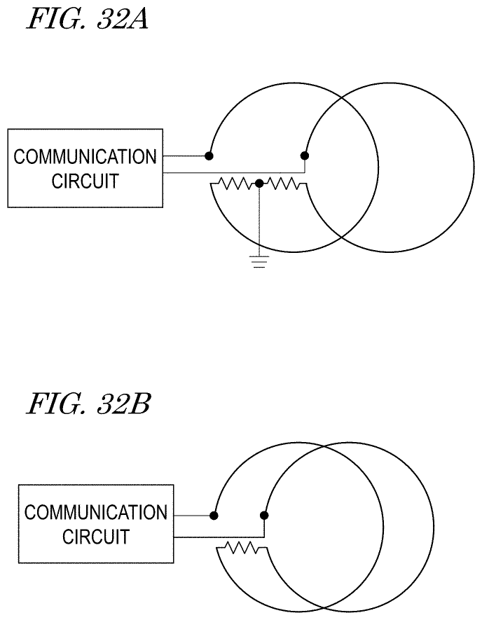

FIG. 32A shows a first example of a method of terminating each differential transmission line. In this example, as in the examples of FIG. 30A to FIG. 31B, one end of each differential transmission line is connected to a terminal of a communication circuit. On the other hand, the other end of each differential transmission line is connected to a terminator. These resistors are connected to each other, this node being grounded. The resistance values of the resistors are set to values that will make the reflection at the terminal ends as small as possible. Thus, a configuration may be adopted where the differential transmission lines are terminated with two resistors, a midpoint between which is grounded. With such a configuration, the termination resistance value can be set to an appropriate value for each line, whereby the potential reference for the terminal ends of the differential lines can be made common.

FIG. 32B shows a second example of a method of terminating each differential transmission line. In this example, an end of each differential transmission line is connected to one terminator. In this example, one resistor employed between the differential lines achieves termination, whereby the number of parts can be reduced.

Thus, with wireless power and data transmission apparatuses according to embodiments of the present disclosure, in each module, antennas for power transmission purposes and communication electrodes are disposed while being shifted in a direction along the axis of rotation. As compared to any configuration in which an antenna and a communication electrode flank each other along a perpendicular direction to the axis C (i.e., a radial direction), such a structure allows the device to have a smaller radius. When the mid position between the inner antenna and the outer antenna and the mid position between the inner communication electrode and the outer communication electrode are shifted from each other, data transmission noise associated with wireless power transmission can be reduced. Furthermore, when at least one electrically-conductive shield is disposed between the antenna and the communication electrode in at least one of the inner module and the outer module, noise can be further reduced.

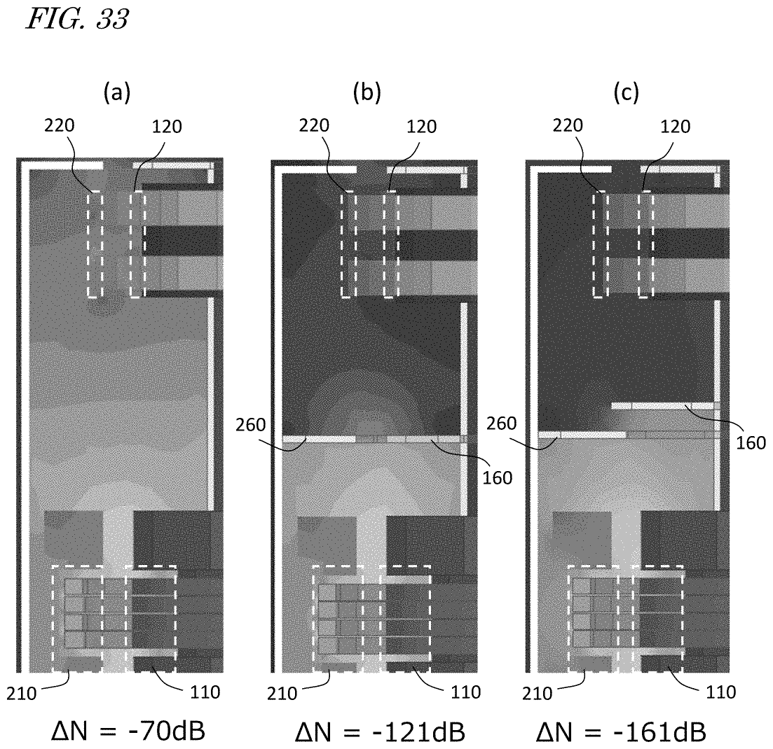

FIG. 33 is a diagram showing results of an analysis which was performed in order to confirm the effects of noise suppression with electrically-conductive shields. In FIG. 33, (a) shows an example of a magnetic field intensity distribution based on a configuration having no shields disposed. In FIG. 33, (b) shows an example of a magnetic field intensity distribution based on a configuration in which two shields are disposed on the same plane. In FIG. 33, (c) shows an example of a magnetic field intensity distribution based on a configuration in which two shields are disposed with an overlap. In FIG. 33, denser region represent lower magnetic field intensities, while sparser regions represent higher magnetic field intensities. In this analysis, each of the communication electrodes 120 and 220 is composed of a differential transmission line pair. The outer antenna 210 is a transmission coil, whereas the inner antenna 110 is a reception coil. The noise intensity of the signal that is output from the outer communication electrode 220 when an AC power of 40 MHz is input to the transmission coil is analyzed with respect to each of the three configurations of (a) to (c) of FIG. 33. Assuming that an input power of the antenna 210 (input port) is Pi=1 [W] and that an output power of the communication electrode 220 is Po[W], a noise attenuation ΔN is expressed by the following equation.

ΔN[dB]=10 log(Po/Pi)

This noise attenuation AN was calculated for each of the configurations of (a) to (c) of FIG. 33. The numerical value in each of the diagrams (a) to (c) of FIG. 33 represents the noise attenuation AN under the respective configuration. The noise attenuations under the configurations of (a) to (c) of FIG. 33 were, respectively, −70 dB, −121 dB, and −161 dB. It was confirmed from these results that disposing the electrically-conductive shields 160 and 260 realize a great noise attenuation, and that disposing the electrically-conductive shields 160 and 260 with an overlap achieves an even greater noise attenuation.

Next, exemplary configurations of systems including wireless power and data transmission apparatuses according to embodiments of the present disclosure will be described. In the following description, it is assumed that electric power is transmitted from the inner module 100 to the outer module 200. In the following description, the inner module 100 may be referred to as the “power transmitting module 100”, the outer module 200 as the “power receiving module 200”, the first antenna 110 as the “transmission coil 110”, and the second antenna 210 as the “reception coil 210”. The system described below will similarly be applicable in the case where the inner module 100 is a power receiving module and the outer module 200 is a power transmitting module.

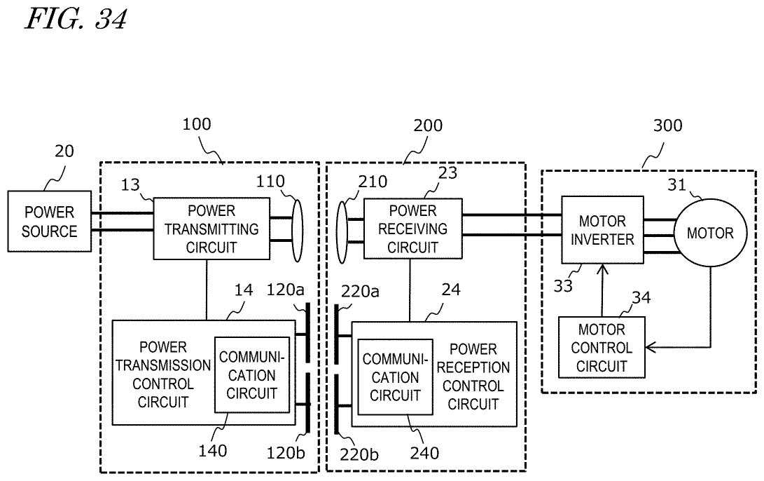

FIG. 34 is a block diagram showing the configuration of a system including the wireless power and data transmission apparatus. This system includes a power source 20, a power transmitting module 100, a power receiving module 200, and a load 300. The load 300 in this example includes a motor 31, a motor inverter 33, and a motor control circuit 34. Without being limited to a device having the motor 31, the load 300 may be any device that operates with electric power, e.g., a battery, a lighting device, or an image sensor. The load 300 may be an electrical storage device, e.g., a secondary battery or a capacitor for electrical storage purposes, that stores electric power. The load 300 may include an actuator including the motor 31 that causes the power transmitting module 100 and the power receiving module 200 to undergo a relative movement (e.g., rotation or linear motion).

The power transmitting module 100 includes a transmission coil 110, communication electrodes 120 (electrodes 120a and 120b), a power transmitting circuit 13, and a power transmission control circuit 14. The power transmitting circuit 13, which is connected between the power source 20 and the transmission coil 110, converts the DC power which is output from the power source 20 into AC power, and outputs it. The transmission coil 110 sends the AC power which is output from the power transmitting circuit 13 into space. The power transmission control circuit 14 may be an integrated circuit including a microcontroller unit (MCU, hereinafter also referred to as a “micon”) and a gate driver circuit, for example. By switching the conducting/non-conducting states of the plurality of switching elements included in the power transmitting circuit 13, the power transmission control circuit 14 controls the frequency and voltage of the AC power which is output from the power transmitting circuit 13. The power transmission control circuit 14 includes a communication circuit 140. The communication circuit 140, which is connected to the electrodes 120a and 120b, also handles exchanges of signals via the electrodes 120a and 120b.

The power receiving module 200 includes a reception coil 210, communication electrodes 220 (electrodes 220a and 220b), a power receiving circuit 23, and a power reception control circuit 125. The reception coil 210 electromagnetically couples with the transmission coil 110, and receives at least a portion of the electric power which has been transmitted from the transmission coil 110. The power receiving circuit 23 includes a rectifier circuit that converts the AC power which is output from the reception coil 210 into e.g. DC power and outputs it. The power reception control circuit 24 includes a communication circuit 240. The communication circuit 240, which is connected to the electrodes 220a and 220b, also handles exchanges of signals via the electrodes 220a and 220b.

The load 300 includes the motor 31, the motor inverter 33, and the motor control circuit 34. Although the motor 31 in this example is a servo motor which is driven with a three-phase current, it may be any other kind of motor. The motor inverter 33 is a circuit that drives the motor 31, including a three-phase inverter circuit. The motor control circuit 34 is a circuit, e.g., an MCU, that controls the motor inverter 33. By switching the conducting/non-conducting states of the plurality of switching elements that are included in the motor inverter 33, the motor control circuit 34 causes the motor inverter 33 to output a three-phase AC power as desired.

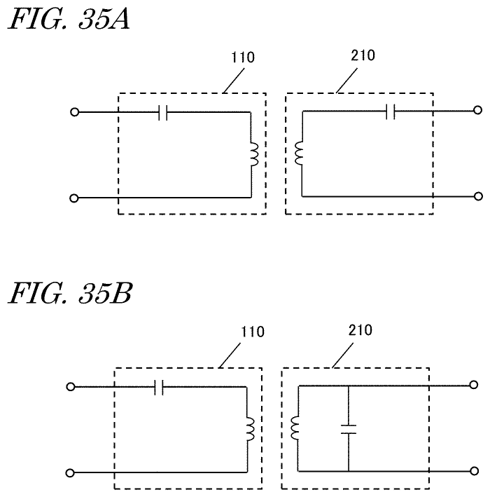

FIG. 35A is a diagram showing an exemplary equivalent circuit for the transmission coil 110 and the reception coil 210 in the wireless power feeding unit 100. As shown in the figure, each coil functions as a resonant circuit having an inductance component and a capacitance component. By ensuring that the resonant frequencies of two coils opposing each other have close values, electric power can be transmitted with a high efficiency. The transmission coil 110 receives AC power supplied from the power transmitting circuit 13. Owing to a magnetic field that is generated with this AC power from the transmission coil 110, electric power is transmitted to the reception coil 210. In this example, the transmission coil 110 and the reception coil 210 both function as series resonant circuits.

FIG. 35B is a diagram showing another exemplary equivalent circuit for the transmission coil 110 and the reception coil 210 in the wireless power feeding unit 100. In this example, the transmission coil 110 functions as a series resonant circuit, whereas the reception coil 210 functions as a parallel resonant circuit. In another possible implementation, the transmission coil 110 may constitute a parallel resonant circuit.

Each coil may be a planar coil or a laminated coil formed on a circuit board, or a wound coil in which a litz wire, a twisted wire, or the like made of a material such as copper or aluminum is used, for example. Each capacitance component in the resonant circuit may be realized by a parasitic capacitance of the coil, or a capacitor having a chip shape or a lead shape may be separately provided, for example.

The resonant frequency f0 of the resonant circuit is typically set to be equal to the transmission frequency f1 during power transmission. It is not necessary for the resonant frequency f0 of each of the resonant circuit to be exactly equal to the transmission frequency f1. The resonant frequency f0 of each may be set to a value in the range of about 50 to about 150% of the transmission frequency f1, for example. The frequency f1 of the power transmission may be e.g. 50 Hz to 300 GHz; 20 kHz to 10 GHz in one example; 20 kHz to 20 MHz in another example; and 80 kHz to 14 MHz in still another example.

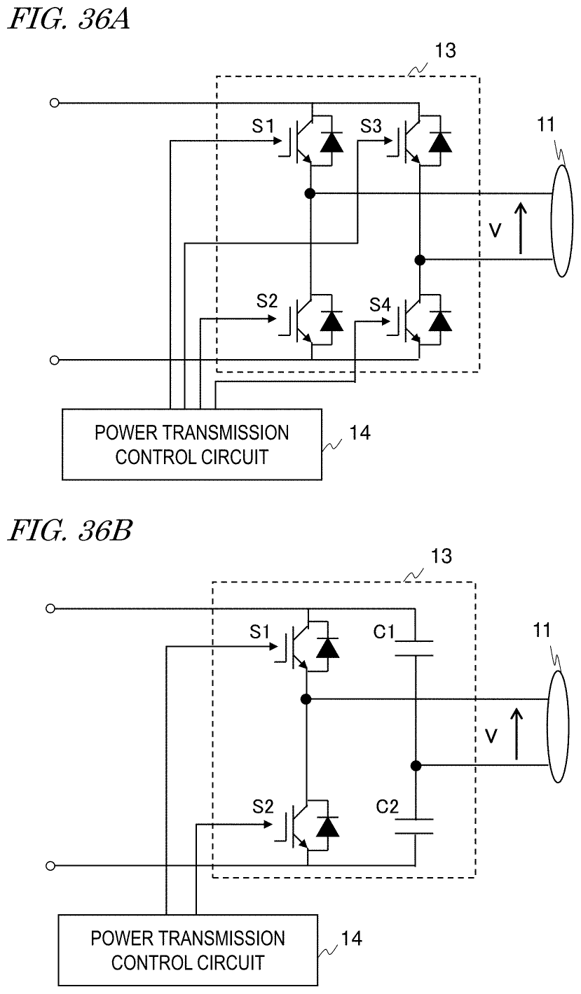

FIGS. 36A and 36B are diagrams showing exemplary configurations for the power transmitting circuit 13. FIG. 36A shows an exemplary configuration of a full-bridge type inverter circuit. In this example, by controlling ON or OFF of the four switching elements S1 to S4 included in the power transmitting circuit 13, the power transmission control circuit 14 converts input DC power into an AC power having a desired frequency f1 and voltage V (effective values). In order to realize this control, the power transmission control circuit 14 may include a gate driver circuit that supplies a control signal to each switching element. FIG. 36B shows an exemplary configuration of a half-bridge type inverter circuit. In this example, by controlling ON or OFF of the two switching elements S1 and S2 included in the power transmitting circuit 13, the power transmission control circuit 14 converts input DC power into an AC power having a desired frequency f1 and voltage V (effective values). The power transmitting circuit 13 may be different in structure from the configurations shown in FIG. 36A and FIG. 36B.

The power transmission control circuit 14, the power reception control circuit 24, and the motor control circuit 34 can be implemented as circuits including a processor and a memory, e.g., microcontroller units (MCU). By executing a computer program which is stored in the memory, various controls can be performed. The power transmission control circuit 14, the power reception control circuit 24, and the motor control circuit 34 may be implemented in special-purpose hardware that is adapted to perform the operation according to the present embodiment. The power transmission control circuit 14 and the power reception control circuit 24 also function as communication circuits. The power transmission control circuit 14 and the power reception control circuit 24 are able to transmit signals or data to each other via the communication electrodes 120 and 220.

The motor 31 may be a motor that is driven with a three-phase current, e.g., a permanent magnet synchronous motor or an induction motor, although this is not a limitation. The motor 31 may any other type of motor, such as a DC motor. In that case, instead of the motor inverter 33 (which is a three-phase inverter circuit), a motor driving circuit which is suited for the structure of the motor 31 is to be used.

The power source 20 may be any power source that outputs DC power. The power source 20 may be any power source, e.g., a mains supply, a primary battery, a secondary battery, a photovoltaic cell, a fuel cell, a USB (Universal Serial Bus) power source, a high-capacitance capacitor (e.g., an electric double layer capacitor), or a voltage converter that is connected to a mains supply, for example.

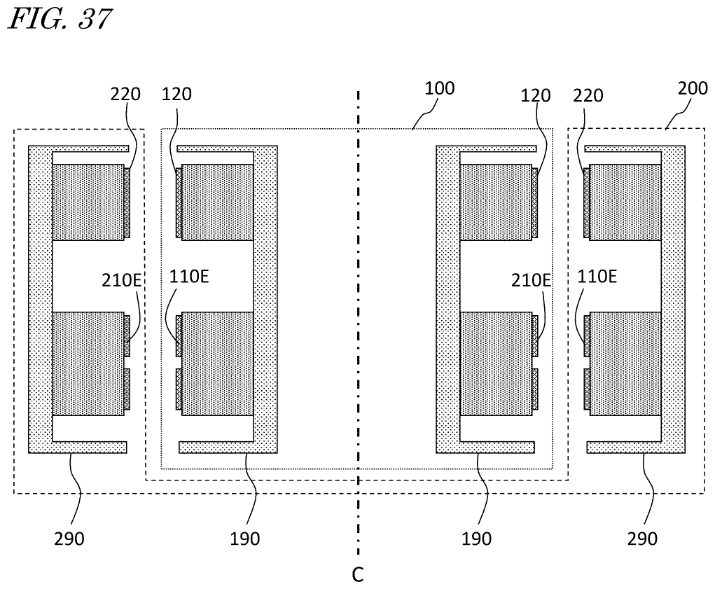

In the above embodiments, coils are used as antennas; instead of coils, however, electrodes which transmit electric power via electric field coupling (also referred to as capacitive coupling) may be used. For example, as shown in FIG. 37, the power transmitting module 100 may include a transmission electrode 110E, and the power receiving module 200 may include a reception electrode 210E. In this case, each of the transmission electrode 110E and the reception electrode 210E may be split into two subportions, such that AC voltages which are opposite in phase are applied to the two subportions.

A wireless power transmission system according to another embodiment of the present disclosure includes a plurality of wireless power feeding units and a plurality of loads. The plurality of wireless power feeding units are connected in series, and each supply electric power to one or more loads connected thereto.

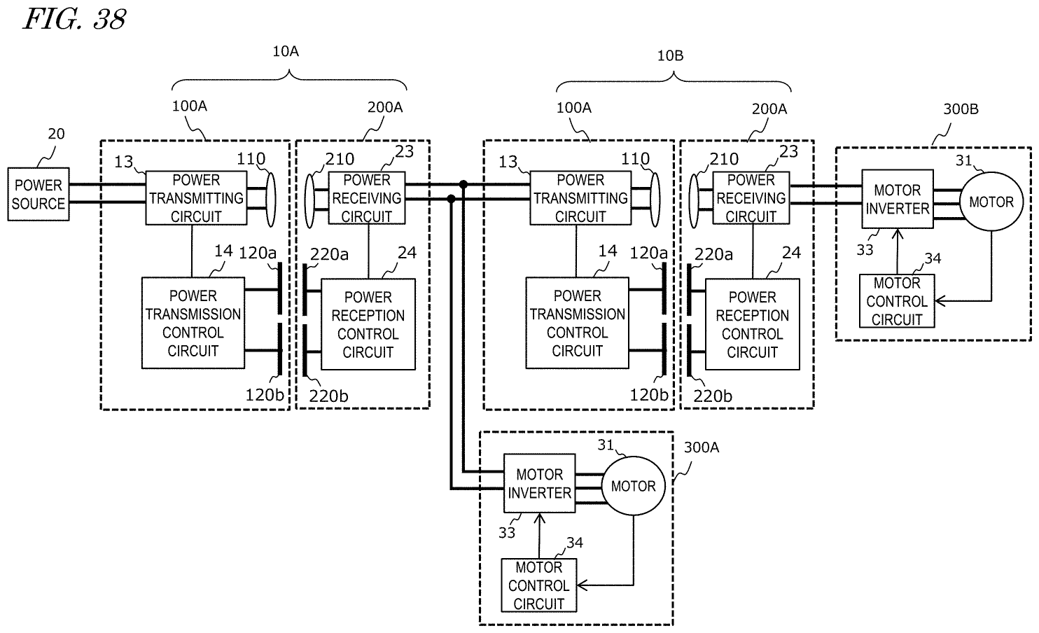

FIG. 38 is a block diagram showing the configuration of a wireless power transmission system including two wireless power feeding units. This wireless power transmission system includes two wireless power feeding units 10A and 10B and two loads 300A and 300B. The number of wireless power feeding units and the number of loads are not limited two, but may each be three or more.

Each power transmitting module 100A, 100B is similar in configuration to the power transmitting module 100 in the above-described embodiment. Each power receiving module 200A, 200B is similar in configuration to the power receiving module 200 in the above-described embodiment. The loads 300A and 300B receive electric power supplied from the power receiving modules 200A and 200B, respectively.

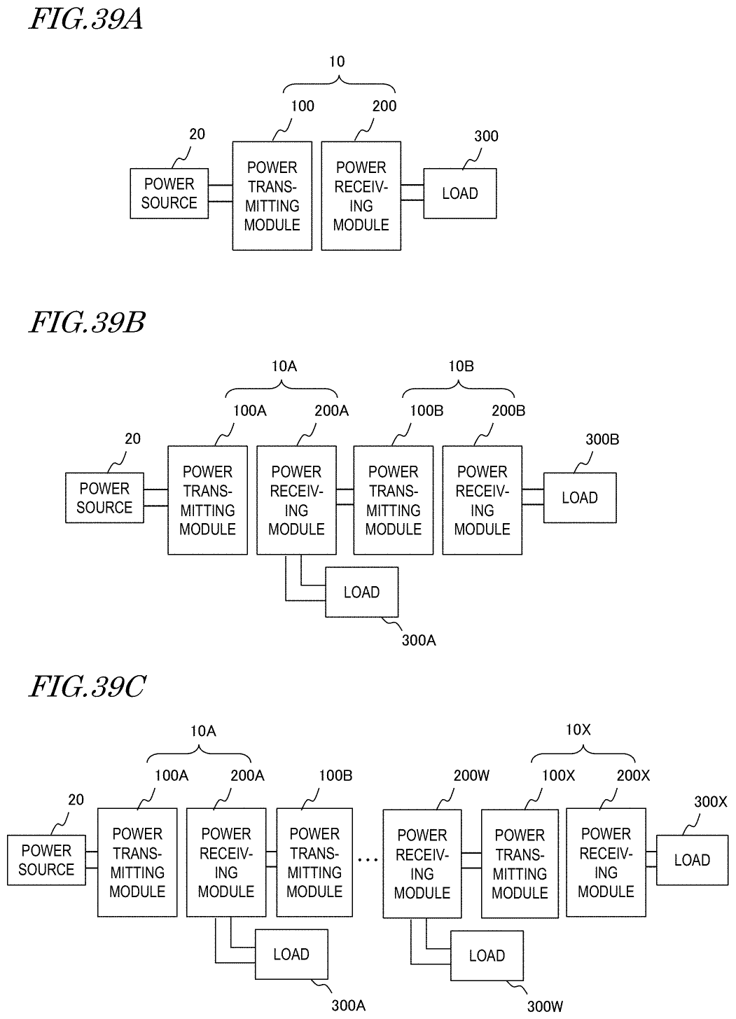

FIGS. 39A to 39C are schematic diagrams showing different types of configuration for the wireless power transmission system according to the present disclosure. FIG. 39A shows a wireless power transmission system which includes one wireless power feeding unit 10. FIG. 39B shows a wireless power transmission system in which two wireless power feeding units 10A and 10B are provided between a power source 20 and a terminal load 300B. FIG. 39C shows a wireless power transmission system in which three or more wireless power feeding units l0A to 10X are provided between a power source 20 and a terminal load device 300X. The technique according to the present disclosure is applicable to any of the implementations of FIGS. 39A to 39C. The configuration shown in FIG. 39C is suitably applicable to an electrically operated apparatus such as a robot having many movable sections, as has been described with reference to FIG. 1, for example.

In the configuration of FIG. 39C, the configuration according to the above-described embodiment may be applied to all of the wireless power feeding units 10A to 10X, or the above-described configuration may be applied to only some of the wireless power feeding units.

### INDUSTRIAL APPLICABILITY

The technique according to the present disclosure is suitably applicable to an electrically operated apparatus such as a robot, a monitor camera, an electric vehicle, or a multicopter to be used in a factory or a site of engineering work, for example.

### REFERENCE SIGNS LIST

10 wireless power feeding unit

13 power transmitting circuit

14 power transmission control circuit

23 power receiving circuit

24 power reception control circuit

31 motor

33 motor inverter

34 motor control circuit

20 power source

100 inner module

110 first antenna

120 first communication electrode

130 magnetic core

140 first communication circuit

150 dielectric member

160 first electrically-conductive shield

190 metal housing

200 power receiving module

210 second antenna

220 second communication electrode

230 magnetic core

240 second communication circuit

250 dielectric member

260 second electrically-conductive shield

290 metal housing

300 load

600 wireless power feeding unit

650 control device

700 miniature motor

900 motor driving circuit

1. A wireless power and data transmission apparatus, comprising:
an inner module; and
an outer module, wherein,
at least one of the inner module and the outer module is disposed so as to be capable of rotating around an axis;
the inner module includes
an annular-shaped first antenna disposed around the axis, and
an annular-shaped first communication electrode disposed around the axis, the first communication electrode being at a different position from that of the first antenna regarding a direction along the axis; and
the outer module includes
an annular-shaped second antenna disposed around the axis, the second antenna performing power transmission or power reception with the first antenna via magnetic field coupling or electric field coupling, and
an annular-shaped second communication electrode disposed around the axis, the second communication electrode being at a different position from that of the second antenna regarding the direction along the axis, and the second antenna performing communications with the first communication electrode via electric field coupling.

2. The wireless power and data transmission apparatus of claim 1, wherein,
the first communication electrode has a diameter which is different from a diameter of the first antenna; and
the second communication electrode has a diameter which is different from a diameter of the second antenna.

3. The wireless power and data transmission apparatus of claim 1, wherein,
the inner module further includes a first electrically-conductive shield between the first antenna and the first communication electrode; and
the outer module further includes a second electrically-conductive shield between the second antenna and the second communication electrode.

4. The wireless power and data transmission apparatus of claim 3, wherein each of the first electrically-conductive shield and the second electrically-conductive shield has an annular shape, and is disposed around the axis.

5. The wireless power and data transmission apparatus of claim 3, wherein,
when viewed in the direction along the axis,
a mid position between the first antenna and the second antenna is different from a mid position between the first communication electrode and the second communication electrode; and
at least one of the first electrically-conductive shield and the second electrically-conductive shield overlaps the mid position between the first antenna and the second antenna.

6. The wireless power and data transmission apparatus of claim 3, wherein,
regarding the direction along the axis, the first electrically-conductive shield is at a different position from a position of the second electrically-conductive shield; and
when viewed in the direction along the axis,
the first electrically-conductive shield and the second electrically-conductive shield partially overlap.

7. The wireless power and data transmission apparatus of claim 3, wherein,
regarding the direction along the axis, the first electrically-conductive shield is located between the second electrically-conductive shield and one of the second antenna and the second communication electrode;
regarding the direction along the axis, the second electrically-conductive shield is located between the first electrically-conductive shield and one of the first communication electrode and the first antenna; and,
in a cross section containing the axis,
an outer peripheral edge of the first electrically-conductive shield is located inside of the one of the second antenna and the second communication electrode, and
an inner peripheral edge of the second electrically-conductive shield is located outside of the one of the first communication electrode and the first antenna.

8. The wireless power and data transmission apparatus of claim 1, wherein sliding one of the inner module and the outer module in the direction along the axis allows the one of the inner module and the outer module to be attached or detached.

9. The wireless power and data transmission apparatus of claim 1, wherein each of the first communication electrode and the second communication electrode includes a differential transmission line pair.

10. The wireless power and data transmission apparatus of claim 1, wherein each of the first antenna second antenna includes a coil.

11. The wireless power and data transmission apparatus of claim 1, further comprising an actuator to rotate the at least one of the inner module and the outer module around the axis.

12. The wireless power and data transmission apparatus of claim 1, further comprising:
a power transmitting circuit that is connected to one of the first antenna and the second antenna to output AC power; and
a power receiving circuit that is connected to another of the first antenna and the second antenna to convert received AC power into another form of electric power.

13. The wireless power and data transmission apparatus of claim 1, further comprising:
a first communication circuit that is connected to one of the first communication electrode and the second communication electrode; and
a second communication circuit that is connected to another of the first communication electrode and the second communication electrode.

14. A transmission module for use as the inner module in the wireless power and data transmission apparatus of claim 1.

15. A transmission module for use as the outer module in the wireless power and data transmission apparatus of claim 1.
